(19) United States
(12) Patent Application Publication
(10) Pub. No.: US 2024/0253326 A1
(43) Pub. Date: Aug. 1, 2024

(54) COMPOSITE STRUCTURES COMPRISING METAL SUBSTRATES

(71) Applicant: PRC-Desoto International, Inc., Sylmar, CA (US)

(72) Inventors: Kenneth William Burtt, Jr., Portland, CT (US); Yong Han Yeong, Valley Village, CA (US); Shawn Patrick Duffy, Cheswick, PA (US); Justin Jonathan Martin, Harrison City, PA (US); Mehran Arbab, Chicago, IL (US); Jonathan A. Love, Natrona Heights, PA (US); Mikhail Khudiakov, Mason, OH (US); Mary Lyn Chong Lim, Pittsburgh, PA (US); Robin Michelle Peffer, Valencia, PA (US)

(73) Assignee: PRC-Desoto International, Inc., Sylmar, CA (US)

(21) Appl. No.: 18/561,465

(22) PCT Filed: May 23, 2022
(86) PCT No.: PCT/US2022/072495

§ 371 Date: Nov. 16, 2023

Related U.S. Application Data
(60) Provisional application No. 63/269,814, filed on Mar. 23, 2022.
(60) Provisional application No. 63/192,659, filed on May 25, 2021.

(51) Int. Cl. B32B 3/26; B32B 15/08; B32B 15/20

(52) U.S. Cl. CPC B32B 3/266; B32B 15/08; B32B 15/20; B32B 2255/06; B32B 2255/26; B32B 2260/02; B32B 2260/046; B32B 2307/206; B32B 2307/7376

(57) ABSTRACT

The present disclosure is directed to a composite structure comprising at least one reinforced polymer layer comprising a reinforcing material; a layer comprising a metal substrate comprising a surface and a conformal organic coating present on at least a portion of the surface; wherein the layer comprising the metal substrate is in direct contact with the reinforced polymer layer, and the reinforcing material is more noble than the metal substrate. Also disclosed is a method of making a composite structure, a surfacing film, and a test method for evaluating the galvanic corrosion resistance of a metal substrate test piece.

### CROSS-REFERENCE TO RELATED APPLICATIONS

This application claims the benefit of U.S. Provisional patent application Ser. No. 63/192,659, filed on May 25, 2021, and U.S. Provisional patent application Ser. No. 63/269,814, filed on Mar. 23, 2022, each of which are incorporated herein by reference.

### FIELD

The present disclosure is directed towards composite structures, methods of making said composite structures, and methods of using said composite structures.

### BACKGROUND

Composite structures typically include a polymer base that is reinforced with a reinforcing material (e.g., carbon fiber), and the composite structures are useful for a variety of purposes because of their high mechanical strength to weight ratio. Composites have been included in aircraft surface components, airframe structure and parts, helicopters fuselage and rotor blades, land-based motor vehicles, marine vehicles, marine structures, windmills, buildings, sporting goods, among other uses. Composite structures are often a multi-layered stack of materials that provide additional functionality to the composite. When thermal or electrical conductivity is desired, metal substrate layers (including porous metal substrate layers) have been added to composites in order to provide lightning strike and electro-magnetic interference protection and potentially aid in de-icing. However, the metal substrate layers are prone to galvanic corrosion when in direct contact with the conductive reinforcing materials. Isolation layers (e.g., fiberglass or plastic isolation plies) are sometimes used to prevent such corrosion, but the isolation layer adds additional weight to the composite, increases the cost of composite structure (due to additional polymer resin infusion) and cycle time. It would be desirable to provide a composite material that is less susceptible to galvanic corrosion without the need for an isolation layer.

### BRIEF DESCRIPTION OF THE DRAWINGS

FIG. 1 shows an isometric view of an aperture of a portion of an expanded metal mesh porous metal substrate.

FIG. 2A and FIG. 2B are cross-sectional SEM images at different magnifications of an exemplary node of a porous metal substrate having rhombus shaped apertures and the conformal coating applied thereon from an electrodepositable coating composition.

FIG. 3A shows a cross-sectional SEM image of an exemplary strand of a porous metal substrate having rhombus shaped apertures and the conformal coating applied thereon from an electrodepositable coating composition. FIG. 3B is a cross-sectional SEM image showing cross-sectional view of additional strands at a reduced magnification and a perspective view of porous metal substrate having the conformal coating.

FIG. 4 is a top-down view showing the dimensions and set-up of a composite structure configurations.

FIG. 5A and FIG. 5B are top-down and side views of aluminum mesh substrate-containing composite structure configurations of the aluminum mesh on a surface-milled carbon composite sheet.

FIG. 5C and FIG. 5D are top-down and side views of aluminum mesh substrate-containing composite structure configurations of the aluminum mesh embedded between two pieces of standard modulus carbon fiber fabrics.

FIG. 6 is a graph showing electrochemical impedance spectroscopy (EIS) test results following corrosion testing described in the Examples section.

FIG. 7 is a graph showing galvanic currents over a 72-hour period of aluminum mesh coated with the electrodeposited coating of Example 3 and an uncoated aluminum mesh where the meshes are in galvanic contact with carbon fiber prepreg.

FIG. 8 shows aircraft-grade composite structures and configurations for galvanic corrosion testing described in the Examples section.

FIG. 9 shows aircraft-grade composite structures and configurations for lightning strike testing described in the Examples section.

### SUMMARY

The present disclosure provides a composite structure comprising at least one reinforced polymer layer comprising a reinforcing material; a layer comprising a metal substrate and a conformal organic coating present on at least a portion of the surface; wherein the layer comprising the metal substrate is in direct contact with the reinforced polymer layer, and the reinforcing material is more noble than the metal substrate.

The present disclosure also provides a method of making a composite structure, the method comprising applying a conformal organic coating to a surface of a metal substrate to form a coated metal substrate; and fixedly adhering the coated metal substrate to at least one reinforced polymer layer comprising a reinforcing material, wherein the coated metal substrate is in direct contact with the reinforced layer, and the reinforcing material is more noble than the metal substrate.

The present disclosure further provides a surfacing film comprising a metal substrate comprising a conformal organic coating present on at least a portion of the surface of the metal substrate.

The present disclosure is further directed to a test method for evaluating the galvanic corrosion resistance of a metal substrate test piece comprising the steps of measuring the weight of the metal substrate test piece; forming a stack comprising the metal substrate test piece and at least one sheet and/or fabric comprising a material that is more noble than the metal substrate test piece; fixedly adhering the stack using at least one non-conductive fastener to maintain contact between the metal substrate test piece and the sheet and/or fabric; subjecting the stack to a corrosion stimulus for a period of time; rinsing and separating the stack; reweighing the metal substrate test piece after it has dried; and comparing the reweighed weight of the metal substrate test piece to the original weight of the metal substrate test piece to determine weight loss.

### DETAILED DESCRIPTION

The present disclosure is directed to a composite structure comprising at least one reinforced polymer layer comprising a reinforcing material; a layer comprising a metal substrate and a conformal organic coating present on at least a portion of the surface; wherein the layer comprising the metal substrate is in direct contact with the reinforced polymer layer, and the reinforcing material is more noble than the metal substrate.

According to the present disclosure, the composite structure comprises at least one reinforced polymer layer comprising a reinforcing material.

The polymer of the reinforced polymer layer may comprise any suitable thermoset or thermoplastic polymer. For example, the polymer layer may comprise an epoxy resin, a polyester resin, a vinyl ester, nylon, a polyetherketoneketone (PEKK), a polyetheretherketone (PEEK), a polyaryletherketone (PAEK), or any other suitable polymer. The polymer serves as a resin matrix for the reinforcing material.

As used herein, the term “reinforcing material” refers to materials added to a polymer matrix that enhance the strength of the polymer matrix. The reinforcing material may comprise any suitable material. For example, the reinforcing material may comprise carbon fiber, chopped fiber, non-continuous fiber, metal flake, or any combination thereof. When the reinforcing material comprises carbon fiber, the reinforced polymer layer is a carbon-fiber reinforced polymer.

The reinforcing material of the reinforced polymer layer may be more noble than the metal substrate. As used herein, the term “more noble” means the reinforcing material has a higher nobility than the metal substrate as determined by the galvanic activity of each. For example, the activity or nobility of a reinforcing material and metal substrate may be determined by reference to the galvanic series, which ranks metal/metal alloys according to their electrochemical potential with reference to a standard electrode, as understood by one skilled in the art. An example of such galvanic series is provided in Atlas Steels' Atlas TECH NOTE NO. 7. “Galvanic Corrosion,” August 2010 (with reference to a Standard Calomel Electrode (S.C.E.)). In determining the relative galvanic activity of the reinforcing material and the metal substrate, the same scale should be used.

The metal substrate may comprise any suitable metal or metal alloy. For example, the metal substrate may comprise aluminum, an aluminum alloy, copper, a copper alloy, or any combination thereof. Other metals include nickel, steel, silver, titanium, zirconium, niobium, iron, zinc, brass, gold, chromium, and phosphor bronze, as well as others.

According to the present disclosure, the metal substrate of the composite structure may comprise a porous metal substrate comprising a surface having a plurality of apertures.

The porous metal substrate may comprise a mesh, an expanded metal, a perforated metal, a woven metal, a grid, or a combination thereof.

As used herein, the term “expanded metal” refers to a metal sheet that has been slit and stretched to a wide array of typically diamond shaped openings.

The thickness of the porous metal substrate without the conformal organic coating is not limited and may depend upon the intended end use of the composite structure. The porous metal substrate may have a thickness of at least 0.015 mm, such as at least 0.02 mm, such as at least 0.08 mm, such as at least 0.10 mm, such as at least 0.15 mm, such as at least 0.20 mm. The porous metal substrate may have a thickness of no more than 1 mm, such as no more than 0.70 mm, such as no more than 0.50 mm, such as no more than 0.30 mm, such as no more than 0.20 mm, such as no more than 0.15 mm, such as no more than 0.10 mm. The porous metal substrate may have a thickness of 0.015 to 1 mm, such as 0.015 to 0.70 mm, such as 0.015 to 0.50 mm, such as 0.015 to 0.30 mm, such as 0.015 to 0.20 mm, such as 0.015 to 0.15 mm, such as 0.015 to 0.10 mm, such as 0.02 to 1 mm, such as 0.02 to 0.70 mm, such as 0.02 to 0.50 mm, such as 0.02 to 0.30 mm, such as 0.02 to 0.20 mm, such as 0.02 to 0.15 mm, such as 0.02 to 0.10 mm, such as 0.08 to 1 mm, such as 0.08 to 0.70 mm, such as 0.08 to 0.50 mm, such as 0.08 to 0.30 mm, such as 0.08 to 0.20 mm, such as 0.08 to 0.15 mm, such as 0.08 to 0.10 mm, such as 0.10 to 1 mm, such as 0.10 to 0.70 mm, such as 0.10 to 0.50 mm, such as 0.10 to 0.30 mm, such as 0.10 to 0.20 mm, such as 0.10 to 0.15 mm, such as 0.15 to 1 mm, such as 0.15 to 0.70 mm, such as 0.15 to 0.50 mm, such as 0.15 to 0.30 mm, such as 0.15 to 0.20 mm, such as 0.20 to 1 mm, such as 0.20 to 0.70 mm, such as 0.20 to 0.50 mm, such as 0.20 to 0.30 mm.

The content and form of the apertures of the porous metal substrate may depend upon the intended end use of the composite structure. For example, the apertures may be uniformly distributed over the entire surface of the porous metal substrate, or a portion of the surface of the porous metal substrate. Alternatively, the apertures may be non-uniformly distributed over the entire surface of the porous metal substrate, or non-uniformly distributed over the entire surface of the porous metal substrate. The apertures may comprise any regular or irregular shape, or any combination thereof. For example, the porous metal substrate may comprise irregular, round, elliptical, triangular, square, rectangular, rhombus, parallelogram, or polygonal shaped apertures, as well as combinations thereof.

The number of apertures is not limited and may depend upon the end use of the composite. The substrate may comprise at least 2 apertures/cm² of the substrate surface, such as at least 5, such as at least 9, such as at least 15, such as at least 20, such as at least 35, such as at least 60, such as at least 100, such as at least 150, such as at least 200. The substrate may comprise no more than 1,400 apertures/cm² of the substrate surface, such as no more than 550, such as no more than 250, such as no more than 175, such as no more than 120, such as no more than 80, such as no more than 60, such as no more than 40, such as no more than 30. The substrate may comprise 2 to 1,400 apertures/cm² of the substrate surface, such as 2 to 550, such as 2 to 250, such as 2 to 175, such as 2 to 120, such as 2 to 80, such as 2 to 60, such as 2 to 40, such as 2 to 30, such as 5 to 1,400, such as 5 to 550, such as 5 to 250, such as 5 to 175, such as 5 to 120, such as 5 to 80, such as 5 to 60, such as 5 to 40, such as 5 to 30, such as 9 to 1,400, such as 9 to 550, such as 9 to 250, such as 9 to 175, such as 9 to 120, such as 9 to 80, such as 9 to 60, such as 9 to 40, such as 9 to 30, such as 15 to 1,400, such as 15 to 550, such as 15 to 250, such as 15 to 175, such as 15 to 120, such as 15 to 80, such as 15 to 60, such as 15 to 40, such as 15 to 30, such as 20 to 1,400, such as 20 to 550, such as 20 to 250, such as 20 to 175, such as 20 to 120, such as 20 to 80, such as 20 to 60, such as 20 to 40, such as 20 to 30, such as 35 to 1,400, such as 35 to 550, such as 35 to 250, such as 35 to 175, such as 35 to 120, such as 35 to 80, such as 35 to 60, such as 35 to 40, such as 60 to 1,400, such as 60 to 550, such as 60 to 250, such as 60 to 175, such as 60 to 120, such as 60 to 80, such as 100 to 1,400, such as 100 to 550, such as 100 to 250, such as 100 to 175, such as 100 to 120, such as 150 to 1,400, such as 150 to 550, such as 150 to 250, such as 150 to 175, such as 200 to 1,400, such as 200 to 550, such as 200 to 250.

The percentage of the porous metal substrate surface area comprising an aperture is not limited and may depend upon the end use of the composite. The apertures may comprise at least 10% of the substrate surface area, such as at least 15%, such as at least 20%, such as at least 30%, such as at least 35%. The apertures may comprise no more than 90% of the substrate surface area, such as no more than 85%, such as no more than 80%. The apertures may comprise 10% to 90% of the substrate surface area, such as 10% to 85%, such as 10% to 80%, such as 15% to 90%, such as 15% to 85%, such as 15% to 80%, such as 20% to 90%, such as 20% to 85%, such as 20% to 80%, such as 30% to 90%, such as 30% to 85%, such as 30% to 80%, such as 35% to 90%, such as 35% to 85%, such as 35% to 80%.

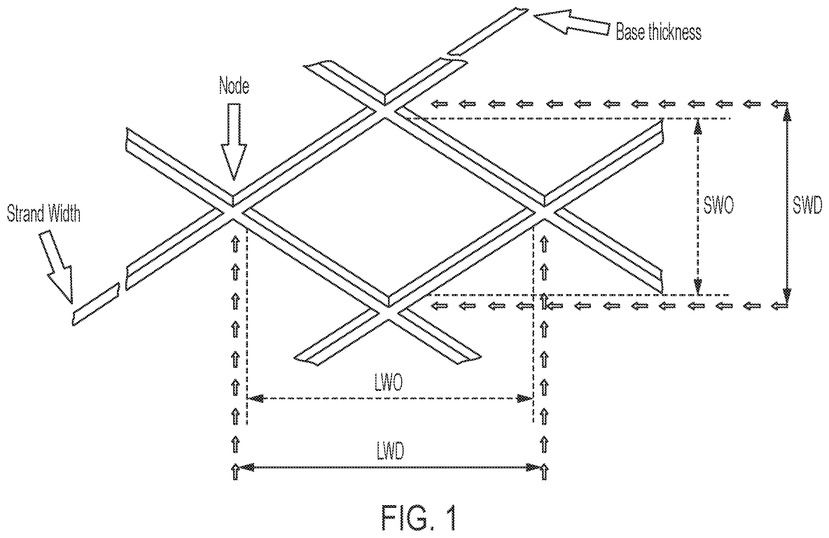

The size of the aperture may also be defined by other metrics depending upon the shape of the aperture. For example, a non-limited example of an expanded metal mesh porous metal substrate is shown in FIG. 1. FIG. 1 shows an aperture of an expanded metal mesh porous metal substrate. The porous metal substrate comprises strands of metal that meet at nodes to form a rhombus (i.e., diamond) shaped aperture. The size of the aperture may be described by referring to the distance between opposite nodes of the rhombus. For example, the shorter distance is denoted by the SWO and SWD notation on the right side of the figure. SWD stands for short way of the diamond and is the length of the short axis way of the diamond, measured from the center of the joint (i.e., node) to the center of the joint. SWO stands for short way of the opening and is the length of the short axis way of the diamond, measured from the opposite vertices of the aperture. The longer distance is denoted by the LWO and LWD notation of the bottom of the figure. LWD stands for long way of the diamond and is the length of the long axis way of the diamond, measured from the center of the joint (i.e., node) to the center of the joint. LWO stands for long way of the opening and is the length of the long axis way of the diamond, measured from the opposite vertices of the aperture.

The SWD and LWD, as well as the SWO and LWO, distances are not limiting and may depend upon the end use of the composite.

The porous metal substrate may comprise apertures having an SWD distance of at least 0.4 mm, such as at least 0.9 mm, such as at least 1.2 mm, such as at least 1.5 mm. The porous metal substrate may comprise apertures having an SWD distance of no more than 10 mm, such as no more than 4 mm, such as no more than 3.5 mm, such as no more than 2.9 mm, such as no more than 2.3 mm, such as no more than 1.8 mm. The porous metal substrate may comprise apertures having an SWD distance of 0.4 to 10 mm, such as 0.4 to 4 mm, such as 0.4 to 3.5 mm, such as 0.4 to 2.9 mm, such as 0.4 to 2.3 mm, such as 0.4 to 1.8 mm, such as 0.9 to 10 mm, such as 0.9 to 4 mm, such as 0.9 to 3.5 mm, such as 0.9 to 2.9 mm, such as 0.9 to 2.3 mm, such as 0.9 to 1.8 mm, such as 1.2 to 10 mm, such as 1.2 to 4 mm, such as 1.2 to 3.5 mm, such as 1.2 to 2.9 mm, such as 1.2 to 2.3 mm, such as 1.2 to 1.8 mm, such as 1.5 to 10 mm, such as 1.5 to 4 mm, such as 1.5 to 3.5 mm, such as 1.5 to 2.9 mm, such as 1.5 to 2.3 mm, such as 1.5 to 1.8 mm.

The porous metal substrate may comprise apertures having an LWD distance of at least 0.5 mm, such as at least 0.7 mm, such as at least 1.5 mm, such as at least 2 mm, such as at least 2.5 mm, such as at least 3 mm. The porous metal substrate may comprise apertures having an LWD distance of no more than 13 mm, such as no more than 7.5 mm, such as no more than 5 mm, such as no more than 3.5 mm, such as no more than 3.2 mm, such as no more than 2.5 mm. The porous metal substrate may comprise apertures having an LWD distance of 0.5 mm to 13 mm, such as 0.5 to 7.5 mm, such as 0.5 to 5 mm, such as 0.5 to 3.5 mm, such as 0.5 to 3.2 mm, such as 0.5 to 2.5 mm, such as 0.7 mm to 13 mm, such as 0.7 to 7.5 mm, such as 0.7 to 5 mm, such as 0.7 to 3.5 mm, such as 0.7 to 3.2 mm, such as 0.7 to 2.5 mm, such as 1.5 to 13 mm, such as 1.5 to 7.5 mm, such as 1.5 to 5 mm, such as 1.5 to 3.5 mm, such as 1.5 to 3.2 mm, such as 1.5 to 2.5 mm, such as 2 to 13 mm, such as 2 to 7.5 mm, such as 2 to 5 mm, such as 2 to 3.5 mm, such as 2 to 3.2 mm, such as 2 to 2.5 mm, such as 2.5 to 13 mm, such as 2.5 to 7.5 mm, such as 2.5 to 5 mm, such as 2.5 to 3.5 mm, such as 2.5 to 3.2 mm, such as 3 to 13 mm, such as 3 to 7.5 mm, such as 3 to 5 mm, such as 3 to 3.5 mm, such as 3 to 3.2 mm.

The aperture aspect ratio is not limited and may depend upon the end use of the composite. As used herein, the aperture “aspect ratio” refers to a ratio of the longest dimension to the longest dimension that runs perpendicular to the longest dimension of the aperture. For example, the aspect ratio for a rhombus (or diamond) shaped aperture would be defined as the LWO divided by the SWO as those terms are defined herein, and the aspect ratio of an elliptical-shaped aperture would be defined as the diameter of its major axis divided by its minor axis. A square or circle would have an aspect ratio of 1:1 or 1. The apertures have an aspect ratio of at 1, such as at least 1.3, such as at least 1.5, such as at least 1.7. The apertures may have an aspect ratio of no more than 15, such as no more than 10, such as no more than 8, such as no more than 6.5, such as no more than 5.5. The aperture may have an aspect ratio of 1 to 15, such as 1 to 10, such as 1 to 8, such as 1 to 6.5, such as 1 to 5.5, such as 1.3 to 15, such as 1.3 to 10, such as 1.3 to 8, such as 1.3 to 6.5, such as 1.3 to 5.5, such as 1.5 to 15, such as 1.5 to 10, such as 1.5 to 8, such as 1.5 to 6.5, such as 1.5 to 5.5, such as 1.7 to 15, such as 1.7 to 10, such as 1.7 to 8, such as 1.7 to 6.5, such as 1.7 to 5.5.

According to the present disclosure, the metal substrate comprises a conformal organic coating present on at least a portion of the surface of the substrate. As used herein, the term “conformal” with respect to an organic coating refers to an organic coating that is present as a continuous or discontinuous film over the surface of the underlying metal substrate that maintains the underlying shape of the metal substrate, including, for a porous metal substrate, a film that maintain the apertures of the porous metal substrate in which the angles, scale or other geometric properties of the apertures are preserved. With respect to the porous metal substrate, the conformal coating film will be present within the apertures of the porous metal substrate and coat the surface of the porous metal substrate that make up the sides of the aperture in the aperture. The film present within the apertures comprises a discontinuous film that generally does not fill or seal the apertures. For example, the coating film will extend into the aperture at a distance equal to the thickness of the film, and the presence of the coating film in the aperture may reduce the surface area of the void of the aperture by less than 50% of the original surface area of the void before the metal substrate is coated, such as less than 30% such as less than 20%, such as less than 10%. The amount of reduction depends on a number of factors including, for example, the size of the aperture, the shape of the aperture, the type of coating film applied, and the thickness of the coating film, among other factors.

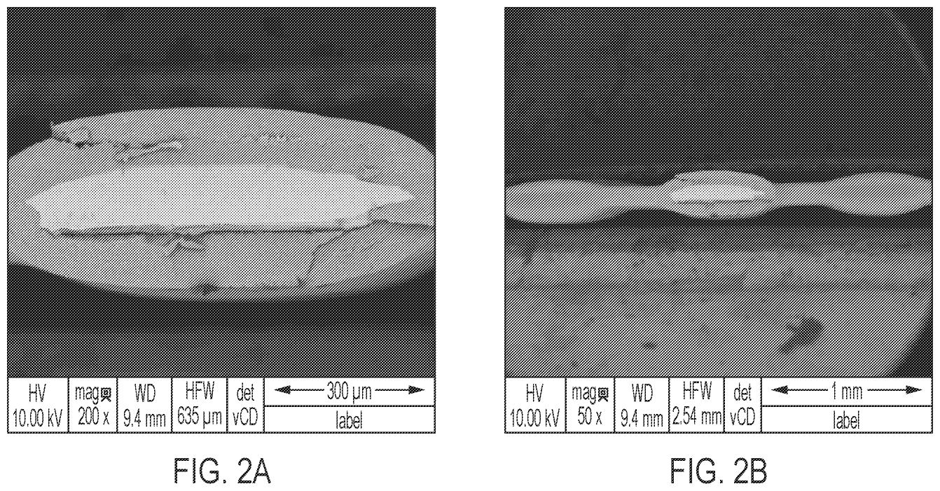

A non-limiting example of a porous metal substrate having a conformal coating is shown in the images of FIG. 2A and FIG. 2B. FIG. 2A shows a cross-sectional SEM image of an exemplary node of a porous metal substrate having rhombus shaped apertures and the conformal coating applied thereon from an electrodepositable coating composition. FIG. 2B is a cross-sectional SEM image of the same node at a reduced magnification that shows the coating conforming to the strands and two adjacent nodes.

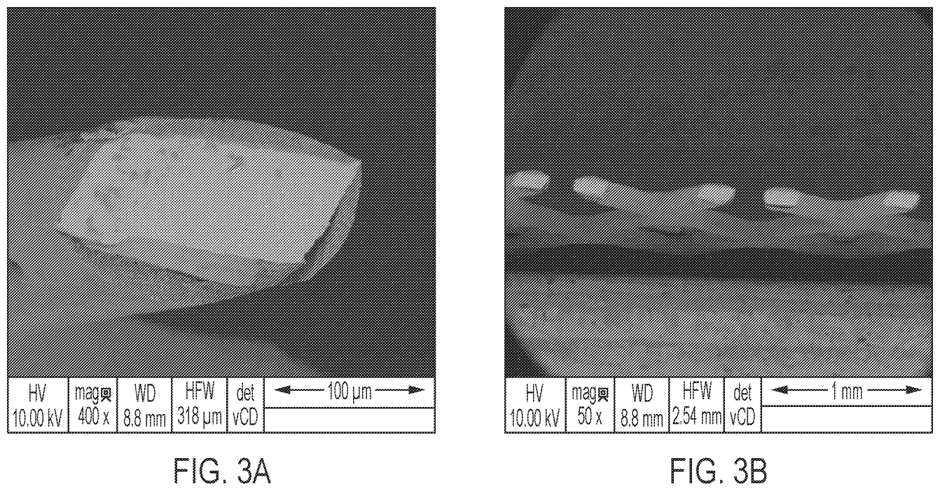

A second non-limiting example of the porous metal substrate having a conformal coating is show in the images of FIG. 3A and FIG. 3B. FIG. 3A shows a cross-sectional SEM image of an exemplary strand of a porous metal substrate having rhombus shaped apertures and the conformal coating applied thereon from an electrodepositable coating composition. FIG. 3B is a cross-sectional SEM image showing cross-sectional view of additional strands at a reduced magnification and a perspective view of porous metal substrate having the conformal coating.

The conformal organic coating thickness is not limited and may be dependent upon the size of the metal substrate (and apertures of a porous metal substrate), the type of coating applied, and the end use of the composite. The conformal organic coating may have a thickness of at least 10 microns, such as at least 25 microns, such as at least 50 microns, such as at least 75 microns, such as at least 100 microns, such as at least 125 microns. The conformal organic coating may have a thickness of no more than 250 microns, such as no more than 200 microns, such as no more than 150 microns, such as no more than 125 microns, such as no more than 100 microns. The conformal organic coating may have a thickness of 10 to 250 microns, such as 10 to 200 microns, such as 10 to 150 microns, such as 10 to 125 microns, such as 10 to 100 microns, such as 25 to 250 microns, such as 25 to 200 microns, such as 25 to 150 microns, such as 25 to 125 microns, such as 25 to 100 microns, such as 50 to 250 microns, such as 50 to 200 microns, such as 50 to 150 microns, such as 50 to 125 microns, such as 50 to 100 microns, such as 75 to 250 microns, such as 75 to 200 microns, such as 75 to 150 microns, such as 75 to 125 microns, such as 75 to 100 microns, such as 100 to 250 microns, such as 100 to 200 microns, such as 100 to 150 microns, such as 100 to 125 microns, such as 125 to 250 microns, such as 125 to 200 microns, such as 125 to 150 microns.

As described in more detail below, the conformal organic coating comprises the residue of a film-forming resin and a curing agent.

The conformal coating may comprise and be deposited from an electrodepositable coating composition. Electrodepositable coating compositions are applied from waterborne compositions through the use of charged resin and an electrical potential. Electrodepositable coating compositions apply coatings having a generally uniform thickness over the surface of conductive substrates and allow for the deposition of the conformal coating of the present disclosure onto the surface of the metal substrate.

The conformal coating may also comprise and be deposited from a spray-applied liquid coating. The spray-applied liquid coating may be uniformly applied in one or more layers over the metal substrate under pressures and thicknesses that allow for the coating to conform to the metal substrate. The spray-applied liquid coating may be applied over both the front and back faces of the metal substrate.

As discussed further below, the film-forming binder of the coating composition used for applying the conformal coating is not limited and may comprise any curable, organic film-forming binder. The binder may be selected based upon the type of coating composition. For example, electrodepositable coating compositions include binders comprising ionic, salt group-containing film-forming polymers whereas other types of curable, film-forming coating compositions, such as liquid, powder, and 100% solids coating compositions, include a curable, organic film-forming binder component that does not require resins having an ionic charge.

According to the present disclosure, the coating composition may be an electrodepositable coating composition, and the film-forming binder of the electrodepositable coating composition may comprise an ionic salt group-containing film-forming polymer.

As used herein, the term “curable” and like terms refers to compositions that undergo a reaction in which they “set” irreversibly, such as when the components of the composition react with each other and the polymer chains of the polymeric components are joined together by covalent bonds. This property is usually associated with a crosslinking reaction of the composition constituents often induced, for example, by heat or radiation. See Hawley, Gessner G., The Condensed Chemical Dictionary, Ninth Edition., page 856; Surface Coatings, vol. 2, Oil and Colour Chemists' Association, Australia, TAFE Educational Books (1974). Curing or crosslinking reactions also may be carried out under ambient conditions. By ambient conditions is meant that the coating undergoes a thermosetting reaction without the aid of heat or other energy, for example, without baking in an oven, use of forced air, or the like. Usually, ambient temperature ranges from 60 to 90° F. (15.6 to 32.2° C.), such as a typical room temperature, 72° F.)(22.2° C.). Once cured or crosslinked, a thermosetting resin will not melt upon the application of heat and is insoluble in solvents.

As used herein, the term “organic film-forming binder component” refers to carbon-based materials (resins, crosslinkers and the like, such as those further described below) that comprise less than 50 wt % of inorganic materials, based on the total weight of the binder component. The organic film-forming binder component may comprise a mixture of organic and inorganic polymers and/or resins so long as the organic content comprises more than 50 wt % of the total weight of the organic film-forming binder component, such as more than 60 wt %, such as more than 70 wt %, such as more than 80 wt %, such as more than 90 wt %. As used herein, “organic content” refers to carbon atoms as well as any hydrogen, oxygen, and nitrogen atoms that are bonded to a carbon atom.

As used herein, the term “electrodepositable coating composition” refers to a composition that is capable of being deposited onto an electrically conductive substrate under the influence of an applied electrical potential.

According to the present disclosure, the ionic salt group-containing film-forming polymer may comprise a cationic salt group containing film-forming polymer. The cationic salt group-containing film-forming polymer may be used in a cationic electrodepositable coating composition. As used herein, the term “cationic salt group-containing film-forming polymer” refers to polymers that include at least partially neutralized cationic groups, such as sulfonium groups and ammonium groups, that impart a positive charge. As used herein, the term “polymer” encompasses, but is not limited to, oligomers and both homopolymers and copolymers. The cationic salt group-containing film-forming polymer may comprise active hydrogen functional groups. As used herein, the term “active hydrogen” or “active hydrogen functional groups” refers to hydrogens which, because of their position in the molecule, display activity according to the Zerewitinoff test, as described in the JOURNAL OF THE AMERICAN CHEMICAL SOCIETY, Vol. 49, page 3181 (1927). Accordingly, active hydrogens include hydrogen atoms attached to oxygen, nitrogen, or sulfur, and thus active hydrogen functional groups include, for example, hydroxyl, thiol, primary amino, and/or secondary amino groups (in any combination). Cationic salt group-containing film-forming polymers that comprise active hydrogen functional groups may be referred to as active hydrogen-containing, cationic salt group-containing film-forming polymers.

Examples of polymers that are suitable for use as the cationic salt group-containing film-forming polymer in the present disclosure include, but are not limited to, alkyd polymers, acrylics, polyepoxides, polyamides, polyurethanes, polyureas, polyethers, and polyesters, among others.

More specific examples of suitable active hydrogen-containing, cationic salt group containing film-forming polymers include polyepoxide-amine adducts, such as the adduct of a polyglycidyl ethers of a polyphenol, such as Bisphenol A, and primary and/or secondary amines, such as are described in U.S. Pat. No. 4,031,050 at col. 3, line 27 to col. 5, line 50, U.S. Pat. No. 4,452,963 at col. 5, line 58 to col. 6, line 66, and U.S. Pat. No. 6,017,432 at col. 2, line 66 to col. 6, line 26, these portions of which being incorporated herein by reference. A portion of the amine that is reacted with the polyepoxide may be a ketimine of a polyamine, as is described in U.S. Pat. No. 4,104,147 at col. 6, line 23 to col. 7, line 23, the cited portion of which being incorporated herein by reference. Also suitable are ungelled polyepoxide-polyoxyalkylenepolyamine resins, such as are described in U.S. Pat. No. 4,432,850 at col. 2, line 60 to col. 5, line 58, the cited portion of which being incorporated herein by reference. In addition, cationic acrylic resins, such as those described in U.S. Pat. No. 3,455,806 at col. 2, line 18 to col. 3, line 61 and 3,928,157 at col. 2, line 29 to col. 3, line 21, these portions of both of which are incorporated herein by reference, may be used.

Besides amine salt group-containing resins, quaternary ammonium salt group-containing resins may also be employed as a cationic salt group-containing film-forming polymer in the present disclosure. Examples of these resins are those which are formed from reacting an organic polyepoxide with a tertiary amine acid salt. Such resins are described in U.S. Pat. No. 3,962,165 at col. 2, line 3 to col. 11, line 7; 3,975,346 at col. 1, line 62 to col. 17, line 25 and 4,001,156 at col. 1, line 37 to col. 16, line 7, these portions of which being incorporated herein by reference. Examples of other suitable cationic resins include ternary sulfonium salt group-containing resins, such as those described in U.S. Pat. No. 3,793,278 at col. 1, line 32 to col. 5, line 20, this portion of which being incorporated herein by reference. Also, cationic resins which cure via a transesterification mechanism, such as described in European Patent Application No. 12463B1 at pg. 2, line 1 to pg. 6, line 25, this portion of which being incorporated herein by reference, may also be employed.

Other suitable cationic salt group-containing film-forming polymers include those that may form photodegradation resistant electrodepositable coating compositions. Such polymers include the polymers comprising cationic amine salt groups which are derived from pendant and/or terminal amino groups that are disclosed in U.S. Patent Application Publication No. 2003/0054193 A1 at paragraphs [0064] to [0088], this portion of which being incorporated herein by reference. Also suitable are the active hydrogen-containing, cationic salt group-containing resins derived from a polyglycidyl ether of a polyhydric phenol that is essentially free of aliphatic carbon atoms to which are bonded more than one aromatic group, which are described in U.S. Patent Application Publication No. 2003/0054193 A1 at paragraphs [0096] to [0123], this portion of which being incorporated herein by reference.

The active hydrogen-containing, cationic salt group-containing film-forming polymer is made cationic and water dispersible by at least partial neutralization with an acid. Suitable acids include organic and inorganic acids. Non-limiting examples of suitable organic acids include formic acid, acetic acid, methanesulfonic acid, and lactic acid. Non-limiting examples of suitable inorganic acids include phosphoric acid and sulfamic acid. By “sulfamic acid” is meant sulfamic acid itself or derivatives thereof such as those having the formula:

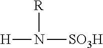

wherein R is hydrogen or an alkyl group having 1 to 4 carbon atoms. Mixtures of the above mentioned acids also may be used in the present disclosure.

The extent of neutralization of the cationic salt group-containing film-forming polymer may vary with the particular polymer involved. However, sufficient acid should be used to sufficiently neutralize the cationic salt-group containing film-forming polymer such that the cationic salt-group containing film-forming polymer may be dispersed in an aqueous dispersing medium. For example, the amount of acid used may provide at least 20% of all of the total theoretical neutralization. Excess acid may also be used beyond the amount required for 100% total theoretical neutralization. For example, the amount of acid used to neutralize the cationic salt group-containing film-forming polymer may be ≥0.1% based on the total amines in the active hydrogen-containing, cationic salt group-containing film-forming polymer. Alternatively, the amount of acid used to neutralize the active hydrogen-containing, cationic salt group-containing film-forming polymer may be ≤100% based on the total amines in the active hydrogen-containing, cationic salt group-containing film-forming polymer. The total amount of acid used to neutralize the cationic salt group-containing film-forming polymer may range between any combination of values, which were recited in the preceding sentences, inclusive of the recited values. For example, the total amount of acid used to neutralize the active hydrogen-containing, cationic salt group-containing film-forming polymer may be 20%, 35%, 50%, 60%, or 80% based on the total amines in the cationic salt group-containing film-forming polymer.

According to the present disclosure, the cationic salt group-containing film-forming polymer may be present in the cationic electrodepositable coating composition in an amount of at least 40% by weight, such as at least 50% by weight, such as at least 60% by weight, and may be present in the in an amount of no more than 90% by weight, such as no more than 80% by weight, such as no more than 75% by weight, based on the total weight of the resin solids of the electrodepositable coating composition. The cationic salt group-containing film-forming polymer may be present in the cationic electrodepositable coating composition in an amount of 40% to 90% by weight, such as 50% to 80% by weight, such as 60% to 75% by weight, based on the total weight of the resin solids of the electrodepositable coating composition.

As used herein, the “resin solids” include the components of the film-forming binder of the coating composition. For example, the resin solids may include film-forming polymers (including ionic salt group-containing film-forming polymer), the curing agent, and any additional water-dispersible non-pigmented component(s) present in the coating composition.

According to the present disclosure, the ionic salt group containing film-forming polymer may comprise an anionic salt group containing film-forming polymer. As used herein, the term “anionic salt group containing film-forming polymer” refers to an anionic polymer comprising at least partially neutralized anionic functional groups, such as carboxylic acid and phosphoric acid groups that impart a negative charge. As used herein, the term “polymer” encompasses, but is not limited to, oligomers and both homopolymers and copolymers. The anionic salt group-containing film-forming polymer may comprise active hydrogen functional groups. As used herein, the term “active hydrogen functional groups” refers to those groups that are reactive with isocyanates as determined by the Zerewitinoff test as discussed above, and include, for example, hydroxyl groups, primary or secondary amine groups, and thiol groups. Anionic salt group-containing film-forming polymers that comprise active hydrogen functional groups may be referred to as active hydrogen-containing, anionic salt group-containing film-forming polymers. The anionic salt group containing film-forming polymer may be used in an anionic electrodepositable coating composition.

The anionic salt group-containing film-forming polymer may comprise base-solubilized, carboxylic acid group-containing film-forming polymers such as the reaction product or adduct of a drying oil or semi-drying fatty acid ester with a dicarboxylic acid or anhydride; and the reaction product of a fatty acid ester, unsaturated acid or anhydride and any additional unsaturated modifying materials which are further reacted with polyol. Also suitable are the at least partially neutralized interpolymers of hydroxy-alkyl esters of unsaturated carboxylic acids, unsaturated carboxylic acid and at least one other ethylenically unsaturated monomer. Still another suitable anionic electrodepositable resin comprises an alkyd-aminoplast vehicle, i.e., a vehicle containing an alkyd resin and an amine-aldehyde resin. Another suitable anionic electrodepositable resin composition comprises mixed esters of a resinous polyol. Other acid functional polymers may also be used such as phosphatized polyepoxide or phosphatized acrylic polymers. Exemplary phosphatized polyepoxides are disclosed in U.S. Patent Application Publication No. 2009-0045071 at [0004]-[0015] and U.S. patent application Ser. No. 13/232,093 at [0014]-[0040], the cited portions of which being incorporated herein by reference. Also suitable are resins comprising one or more pendent carbamate functional groups, such as those described in U.S. Pat. No. 6,165,338.

Also suitable are phosphated epoxy resins comprising at least one terminal group comprising a phosphorous atom covalently bonded to the resin by a carbon-phosphorous bond or by a phosphoester linkage, and at least one carbamate functional group. Non-limiting examples of such resins are described in U.S. patent application Ser. No. 16/019,590 at par. [0012] to [0040].

According to the present disclosure, the anionic salt group-containing film-forming polymer may be present in the anionic electrodepositable coating composition in an amount of at least 50% by weight, such as at least 55% by weight, such as at least 60% by weight, and may be present in an amount of no more than 90% by weight, such as no more than 80% by weight, such as no more than 75% by weight, based on the total weight of the resin solids of the electrodepositable coating composition. The anionic salt group-containing film-forming polymer may be present in the anionic electrodepositable coating composition in an amount 50% to 90%, such as 55% to 80%, such as 60% to 75%, based on the total weight of the resin solids of the electrodepositable coating composition. As used herein, the “resin solids” include the ionic salt group-containing film-forming polymer, the curing agent, and any additional water-dispersible non-pigmented component(s) present in the electrodepositable coating composition.

The film-forming binder may comprise a curable, organic film-forming binder comprising an organic film-forming resin component.

The organic film-forming binder component may comprise (a) a resin component comprising reactive functional groups; and (b) a curing agent component comprising functional groups that are reactive with the functional groups in the resin component (a), although the film-forming binder component may also contain resin that will crosslink with itself rather than (or in addition to) an additional curing agent (i.e., self-crosslinking).

The resin component (a) used in the organic film-forming binder component of the curable film-forming compositions of the present disclosure may comprise one or more of acrylic polymers, polyesters, polyurethanes, polyamides, polyethers, polythioethers, polythioesters, polythiols, polyenes, polyols, polysilanes, polysiloxanes, fluoropolymers, polycarbonates, and epoxy resins. Generally, these compounds, which need not be polymeric, can be made by any method known to those skilled in the art. The functional groups on the film-forming binder may comprise at least one of carboxylic acid groups, amine groups, epoxide groups, hydroxyl groups, thiol groups, carbamate groups, amide groups, urea groups, (meth)acrylate groups, styrenic groups, vinyl groups, allyl groups, aldehyde groups, acetoacetate groups, hydrazide groups, cyclic carbonate, ketone groups, carbodiimide groups, oxazoline groups, alkoxy-silane functional groups, isocyanato functional groups, and maleic acid or anhydride groups. The functional groups on the film-forming binder are selected so as to be reactive with those on the curing agent (b) or to be self-crosslinking.

Suitable acrylic compounds include copolymers of one or more alkyl esters of acrylic acid or methacrylic acid, optionally together with one or more other polymerizable ethylenically unsaturated monomers. Useful alkyl esters of acrylic acid or methacrylic acid include aliphatic alkyl esters containing from 1 to 30, and often 4 to 18 carbon atoms in the alkyl group. Non-limiting examples include methyl methacrylate, ethyl methacrylate, butyl methacrylate, ethyl acrylate, butyl acrylate, and 2-ethyl hexyl acrylate. Suitable other copolymerizable ethylenically unsaturated monomers include vinyl aromatic compounds such as styrene and vinyl toluene; nitriles such as acrylonitrile and methacrylonitrile; vinyl and vinylidene halides such as vinyl chloride and vinylidene fluoride and vinyl esters such as vinyl acetate.

The acrylic copolymer can include hydroxyl functional groups, which are often incorporated into the polymer by including one or more hydroxyl functional monomers in the reactants used to produce the copolymer. Useful hydroxyl functional monomers include hydroxyalkyl acrylates and methacrylates, typically having 2 to 4 carbon atoms in the hydroxyalkyl group, such as hydroxyethyl acrylate, hydroxypropyl acrylate, 4-hydroxybutyl acrylate, hydroxy functional adducts of caprolactone and hydroxyalkyl acrylates, and corresponding methacrylates, as well as the beta-hydroxy ester functional monomers described below. The acrylic polymer can also be prepared with N-(alkoxymethyl)acrylamides and N-(alkoxymethyl)methacrylamides.

Beta-hydroxy ester functional monomers can be prepared from ethylenically unsaturated, epoxy functional monomers and carboxylic acids having from about 13 to about 20 carbon atoms, or from ethylenically unsaturated acid functional monomers and epoxy compounds containing at least 5 carbon atoms that are not polymerizable with the ethylenically unsaturated acid functional monomer.

Useful ethylenically unsaturated, epoxy functional monomers used to prepare the beta-hydroxy ester functional monomers include glycidyl acrylate, glycidyl methacrylate, allyl glycidyl ether, methallyl glycidyl ether, 1:1 (molar) adducts of ethylenically unsaturated monoisocyanates with hydroxy functional monoepoxides such as glycidol, and glycidyl esters of polymerizable polycarboxylic acids such as maleic acid. (Note: these epoxy functional monomers may also be used to prepare epoxy functional acrylic polymers.) Examples of carboxylic acids include saturated monocarboxylic acids such as isostearic acid and aromatic unsaturated carboxylic acids.

Useful ethylenically unsaturated acid functional monomers used to prepare the beta-hydroxy ester functional monomers include monocarboxylic acids such as acrylic acid, methacrylic acid, crotonic acid; dicarboxylic acids such as itaconic acid, maleic acid and fumaric acid; and monoesters of dicarboxylic acids such as monobutyl maleate and monobutyl itaconate. The ethylenically unsaturated acid functional monomer and epoxy compound are typically reacted in a 1:1 equivalent ratio. The epoxy compound does not contain ethylenic unsaturation that would participate in free radical-initiated polymerization with the unsaturated acid functional monomer. Useful epoxy compounds include 1,2-pentene oxide, styrene oxide and glycidyl esters or ethers, often containing from 8 to 30 carbon atoms, such as butyl glycidyl ether, octyl glycidyl ether, phenyl glycidyl ether and para-(tertiary butyl) phenyl glycidyl ether. Particular glycidyl esters include those of the structure:

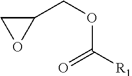

where R₁ is a hydrocarbon radical containing from about 4 to about 26 carbon atoms. Typically, R is a branched hydrocarbon group having from about 5 to about 10 carbon atoms, such as about 8 to about 10 carbon atoms, such as neopentanoate, neoheptanoate or neodecanoate. Suitable glycidyl esters of carboxylic acids include VERSATIC ACID 911 and CARDURA E, each of which is commercially available from Shell Chemical Co.

Carbamate functional groups can be included in the acrylic polymer by copolymerizing the acrylic monomers with a carbamate functional vinyl monomer, such as a carbamate functional alkyl ester of methacrylic acid, or by reacting a hydroxyl functional acrylic polymer with a low molecular weight carbamate functional material, such as can be derived from an alcohol or glycol ether, via a transcarbamoylation reaction. In this reaction, a low molecular weight carbamate functional material derived from an alcohol or glycol ether is reacted with the hydroxyl groups of the acrylic polyol, yielding a carbamate functional acrylic polymer and the original alcohol or glycol ether. The low molecular weight carbamate functional material derived from an alcohol or glycol ether may be prepared by reacting the alcohol or glycol ether with urea in the presence of a catalyst. Suitable alcohols include lower molecular weight aliphatic, cycloaliphatic, and aromatic alcohols such as methanol, ethanol, propanol, butanol, cyclohexanol, 2-ethylhexanol, and 3-methylbutanol. Suitable glycol ethers include ethylene glycol methyl ether and propylene glycol methyl ether. Propylene glycol methyl ether and methanol are most often used. Other carbamate functional monomers as known to those skilled in the art may also be used.

Amide functionality may be introduced to the acrylic polymer by using suitably functional monomers in the preparation of the polymer, or by converting other functional groups to amido-groups using techniques known to those skilled in the art. Likewise, other functional groups may be incorporated as desired using suitably functional monomers if available or conversion reactions as necessary.

Acrylic polymers can be prepared via aqueous emulsion polymerization techniques and used directly in the preparation of aqueous coating compositions or can be prepared via organic solution polymerization techniques for solventborne compositions. When prepared via organic solution polymerization with groups capable of salt formation such as acid or amine groups, upon neutralization of these groups with a base or acid the polymers can be dispersed into aqueous medium. Generally, any method of producing such polymers that is known to those skilled in the art utilizing art recognized amounts of monomers can be used.

The resin component (a) in the film-forming binder component of the curable film-forming composition may comprise an alkyd resin or a polyester. Such polymers may be prepared in a known manner by condensation of polyhydric alcohols and polycarboxylic acids. Suitable polyhydric alcohols include, but are not limited to, ethylene glycol, propylene glycol, butylene glycol, 1,6-hexylene glycol, neopentyl glycol, diethylene glycol, glycerol, trimethylol propane, and pentaerythritol. Suitable polycarboxylic acids include, but are not limited to, succinic acid, adipic acid, azelaic acid, sebacic acid, maleic acid, fumaric acid, phthalic acid, tetrahydrophthalic acid, hexahydrophthalic acid, and trimellitic acid. Besides the polycarboxylic acids mentioned above, functional equivalents of the acids such as anhydrides where they exist or lower alkyl esters of the acids such as the methyl esters may be used. Where it is desired to produce air-drying alkyd resins, suitable drying oil fatty acids may be used and include, for example, those derived from linseed oil, soya bean oil, tall oil, dehydrated castor oil, or tung oil.

Likewise, polyamides may be prepared utilizing polyacids and polyamines. Suitable polyacids include those listed above and polyamines may be comprise, for example, ethylene diamine, 1,2-diaminopropane, 1,4-diaminobutane, 1,3-diaminopentane, 1,6-diaminohexane, 2-methyl-1,5-pentane diamine, 2,5-diamino-2,5-dimethylhexane, 2,2,4- and/or 2,4,4-trimethyl-1,6-diamino-hexane, 1,11-diaminoundecane, 1,12-diaminododecane, 1,3- and/or 1,4-cyclohexane diamine, 1-amino-3,3,5-trimethyl-5-aminomethyl-cyclohexane, 2,4- and/or 2,6-hexahydrotoluylene diamine, 2,4′- and/or 4,4′-diamino-dicyclohexyl methane and 3,3′-dialkyl4,4′-diamino-dicyclohexyl methanes (such as 3,3′-dimethyl-4,4′-diamino-dicyclohexyl methane and 3,3′-diethyl-4,4′-diamino-dicyclohexyl methane), 2,4- and/or 2,6-diaminotoluene and 2,4′- and/or 4,4′-diaminodiphenyl methane.

Carbamate functional groups may be incorporated into the polyester or polyamide by first forming a hydroxyalkyl carbamate which can be reacted with the polyacids and polyols/polyamines used in forming the polyester or polyamide. The hydroxyalkyl carbamate is condensed with acid functionality on the polymer, yielding terminal carbamate functionality. Carbamate functional groups may also be incorporated into the polyester by reacting terminal hydroxyl groups on the polyester with a low molecular weight carbamate functional material via a transcarbamoylation process similar to the one described above in connection with the incorporation of carbamate groups into the acrylic polymers, or by reacting isocyanic acid with a hydroxyl functional polyester.

Other functional groups such as amine, amide, thiol, urea, or others listed above may be incorporated into the polyamide, polyester or alkyd resin as desired using suitably functional reactants if available, or conversion reactions as necessary to yield the desired functional groups. Such techniques are known to those skilled in the art.

Polyurethanes can also be used as the resin component (a) in the film-forming binder component of the curable film-forming composition. Among the polyurethanes that can be used are polymeric polyols, which generally are prepared by reacting the polyester polyols or acrylic polyols such as those mentioned above with a polyisocyanate such that the OH/NCO equivalent ratio is greater than 1:1 so that free hydroxyl groups are present in the product. The organic polyisocyanate that is used to prepare the polyurethane polyol can be an aliphatic or an aromatic polyisocyanate or a mixture of the two. Diisocyanates are typically used, although higher polyisocyanates can be used in place of or in combination with diisocyanates. Examples of suitable aromatic diisocyanates are 4,4′-diphenylmethane diisocyanate and toluene diisocyanate. Examples of suitable aliphatic diisocyanates are straight chain aliphatic diisocyanates such as 1,6-hexamethylene diisocyanate. Also, cycloaliphatic diisocyanates can be employed. Examples include isophorone diisocyanate and 4,4′-methylene-bis-(cyclohexyl isocyanate). Examples of suitable higher polyisocyanates are 1,2,4-benzene triisocyanate polymethylene polyphenyl isocyanate, and isocyanate trimers based on 1,6-hexamethylene diisocyanate or isophorone diisocyanate. As with the polyesters, the polyurethanes can be prepared with unreacted carboxylic acid groups, which, upon neutralization with bases such as amines, allows for dispersion into aqueous medium.

Terminal and/or pendent carbamate functional groups can be incorporated into the polyurethane by reacting a polyisocyanate with a polymeric polyol containing the terminal/pendent carbamate groups. Alternatively, carbamate functional groups can be incorporated into the polyurethane by reacting a polyisocyanate with a polyol and a hydroxyalkyl carbamate or isocyanic acid as separate reactants. Carbamate functional groups can also be incorporated into the polyurethane by reacting a hydroxyl functional polyurethane with a low molecular weight carbamate functional material via a transcarbamoylation process similar to the one described above in connection with the incorporation of carbamate groups into the acrylic polymer. Additionally, an isocyanate functional polyurethane can be reacted with a hydroxyalkyl carbamate to yield a carbamate functional polyurethane.

Other functional groups such as amide, thiol, urea, or others listed above may be incorporated into the polyurethane as desired using suitably functional reactants if available, or conversion reactions as necessary to yield the desired functional groups. Such techniques are known to those skilled in the art.

Examples of polyether polyols are polyalkylene ether polyols which include those having the following structural formula:

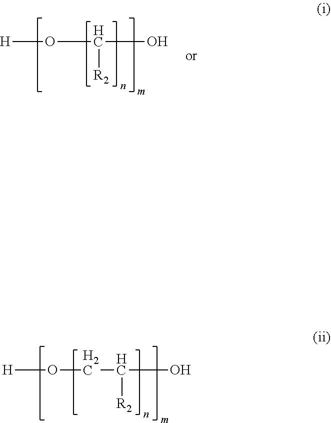

where each substituent R₂ may be independently selected from hydrogen or a lower alkyl containing from 1 to 5 carbon atoms, n is typically from 2 to 6 and m is from 8 to 100 or higher. Included are poly(oxytetramethylene) glycols, poly(oxytetraethylene) glycols, poly(oxy-1,2-propylene) glycols, and poly(oxy-1,2-butylene) glycols.

Also useful are polyether polyols formed from oxyalkylation of various polyols, for example, diols such as ethylene glycol, 1,6-hexanediol, Bisphenol A and the like, or other higher polyols such as trimethylolpropane, pentaerythritol, and the like. Polyols of higher functionality which can be utilized as indicated can be made, for instance, by oxyalkylation of compounds such as sucrose or sorbitol. One commonly utilized oxyalkylation method is reaction of a polyol with an alkylene oxide, for example, propylene or ethylene oxide, in the presence of an acidic or basic catalyst. Particular polyethers include those sold under the names TERATHANE and TERACOL, available from The Lycra Company, and POLYMEG, available from LyondellBasell.

Carbamate functional groups may be incorporated into the polyethers by a transcarbamoylation reaction. Other functional groups such as acid, amine, epoxide, amide, thiol, and urea may be incorporated into the polyether as desired using suitably functional reactants if available, or conversion reactions as necessary to yield the desired functional groups. Examples of suitable amine functional polyethers include those sold under the name JEFFAMINE, such as JEFFAMINE D2000, a polyether functional diamine available from Huntsman Corporation.

Suitable epoxy functional polymers for use as the resin component (a) may include a polyepoxide chain extended by reacting together a polyepoxide and a polyhydroxyl group-containing material selected from alcoholic hydroxyl group-containing materials and phenolic hydroxyl group-containing materials to chain extend or build the molecular weight of the polyepoxide.

A chain extended polyepoxide is typically prepared by reacting together the polyepoxide and polyhydroxyl group-containing material neat or in the presence of an inert organic solvent such as a ketone, including methyl isobutyl ketone and methyl amyl ketone, aromatics such as toluene and xylene, and glycol ethers such as the dimethyl ether of diethylene glycol. The reaction is usually conducted at a temperature of 80° C. to 160° C. for 30 to 180 minutes until an epoxy group-containing resinous reaction product is obtained.

The equivalent ratio of reactants, i.e., epoxy:polyhydroxyl group-containing material is typically from about 1.00:0.75 to 1.00:2.00. It will be appreciated by one skilled in the art that the chain extended polyepoxide will lack epoxide functional groups when reacted with the polyhydroxyl group-containing material such that an excess of hydroxyl functional groups are present. The resulting polymer will comprise hydroxyl functional groups resulting from the excess of hydroxyl functional groups and the hydroxyl functional groups produced by the ring-opening reaction of the epoxide functional groups.

The polyepoxide by definition has at least two 1,2-epoxy groups. In general, the epoxide equivalent weight of the polyepoxide may range from 100 to 2000, such as from 180 to 500. The epoxy compounds may be saturated or unsaturated, cyclic or acyclic, aliphatic, alicyclic, aromatic or heterocyclic. They may contain substituents such as halogen, hydroxyl, and ether groups.

Examples of polyepoxides are those having a 1,2-epoxy equivalency of one to two, such as greater than one and less than two or of two; that is, polyepoxides that have on average two epoxide groups per molecule. The most commonly used polyepoxides are polyglycidyl ethers of cyclic polyols, for example, polyglycidyl ethers of polyhydric phenols such as Bisphenol A, resorcinol, hydroquinone, benzenedimethanol, phloroglucinol, and catechol; or polyglycidyl ethers of polyhydric alcohols such as alicyclic polyols, particularly cycloaliphatic polyols such as 1,2-cyclohexane diol, 1,4-cyclohexane diol, 2,2-bis(4-hydroxycyclohexyl)propane, 1,1-bis(4-hydroxycyclohexyl)ethane, 2-methyl-1,1-bis(4-hydroxycyclohexyl)propane, 2,2-bis(4-hydroxy-3-tertiarybutylcyclohexyl)propane, 1,3-bis(hydroxymethyl)cyclohexane and 1,2-bis(hydroxymethyl)cyclohexane. Examples of aliphatic polyols include, inter alia, trimethylpentanediol and neopentyl glycol.

Polyhydroxyl group-containing materials used to chain extend or increase the molecular weight of the polyepoxide may additionally be polymeric polyols such as any of those disclosed above. The present disclosure may comprise epoxy resins such as diglycidyl ethers of Bisphenol A, Bisphenol F, glycerol, novolacs, and the like. Exemplary suitable polyepoxides are described in U.S. Pat. No. 4,681,811 at column 5, lines 33 to 58, the cited portion of which is incorporated by reference herein. Non-limiting examples of suitable commercially available epoxy resins include EPON 828 and EPON 1001, both available from Momentive, and D.E.N. 431 available from Dow Chemical Co.

Epoxy functional film-forming polymers may alternatively be acrylic polymers prepared with epoxy functional monomers such as glycidyl acrylate, glycidyl methacrylate, allyl glycidyl ether, and methallyl glycidyl ether. Polyesters, polyurethanes, or polyamides prepared with glycidyl alcohols or glycidyl amines, or reacted with an epihalohydrin are also suitable epoxy functional resins. Epoxide functional groups may be incorporated into a resin by reacting hydroxyl groups on the resin with an epihalohydrin or dihalohydrin such as epichlorohydrin or dichlorohydrin in the presence of alkali.

Nonlimiting examples of suitable fluoropolymers include fluoroethylene-alkyl vinyl ether alternating copolymers (such as those described in U.S. Pat. No. 4,345,057) available from Asahi Glass Company under the name LUMIFLON; fluoroaliphatic polymeric esters commercially available from 3M of St. Paul, Minnesota under the name FLUORAD; and perfluorinated hydroxyl functional (meth)acrylate resins.

The amount of resin component (a) in the curable film-forming composition may range from 10 to 90% by weight, based on the total weight of resin solids in the curable film-forming composition. For example, the minimum amount of resin may be at least 10% by weight, such as at least 20% by weight or at least 30% by weight, based on the total weight of resin solids in the curable film-forming composition. The maximum amount of resin may be 90% by weight, such as 80% by weight, or 70% by weight. Ranges of resin component may include, for example, 20 to 80% by weight, 50 to 90% by weight, 60 to 80% by weight, 25 to 75% by weight, based on the total weight of resin solids in the curable film-forming composition.

According to the present disclosure, the coating composition used to form the conformal coating of the present disclosure may further comprise a curing agent. The curing agent may react with the reactive groups, such as active hydrogen groups, of the ionic salt group-containing film-forming polymer to effectuate cure of the coating composition to form a coating. As used herein, the term “cure”, “cured” or similar terms, as used in connection with the coating compositions described herein, means that at least a portion of the components that form the coating composition are crosslinked to form a coating. Additionally, curing of the coating composition refers to subjecting said composition to curing conditions (e.g., elevated temperature) leading to the reaction of the reactive functional groups of the components of the coating composition, and resulting in the crosslinking of the components of the composition and formation of an at least partially cured coating. Non-limiting examples of suitable curing agents are at least partially blocked polyisocyanates, aminoplast resins and phenoplast resins, such as phenolformaldehyde condensates including allyl ether derivatives thereof.

According to the present disclosure, the film-forming binder component of the electrodepositable coating composition used to form the conformal coating may further comprise a curing agent. The current agent may comprise, for example, an at least partially blocked polyisocyanate, aminoplast resin, phenoplast resin, or any combination thereof.

Suitable at least partially blocked polyisocyanates include aliphatic polyisocyanates, aromatic polyisocyanates, and mixtures thereof. The curing agent may comprise an at least partially blocked aliphatic polyisocyanate. Suitable at least partially blocked aliphatic polyisocyanates include, for example, fully blocked aliphatic polyisocyanates, such as those described in U.S. Pat. No. 3,984,299 at col. 1 line 57 to col. 3 line 15, this portion of which is incorporated herein by reference, or partially blocked aliphatic polyisocyanates that are reacted with the polymer backbone, such as is described in U.S. Pat. No. 3,947,338 at col. 2 line 65 to col. 4 line 30, this portion of which is also incorporated herein by reference. By “blocked” is meant that the isocyanate groups have been reacted with a compound such that the resultant blocked isocyanate group is stable to active hydrogens at ambient temperature but reactive with active hydrogens in the film forming polymer at elevated temperatures, such as between 90° C. and 200° C. The polyisocyanate curing agent may be a fully blocked polyisocyanate with substantially no free isocyanate groups.

The polyisocyanate curing agent may comprise a diisocyanate, higher functional polyisocyanates or combinations thereof. For example, the polyisocyanate curing agent may comprise aliphatic and/or aromatic polyisocyanates. Aliphatic polyisocyanates may include (i) alkylene isocyanates, such as trimethylene diisocyanate, tetramethylene diisocyanate, pentamethylene diisocyanate, hexamethylene diisocyanate (“HDI”), 1,2-propylene diisocyanate, 1,2-butylene diisocyanate, 2,3-butylene diisocyanate, 1,3-butylene diisocyanate, ethylidene diisocyanate, and butylidene diisocyanate, and (ii) cycloalkylene isocyanates, such as 1,3-cyclopentane diisocyanate, 1,4-cyclohexane diisocyanate, 1,2-cyclohexane diisocyanate, isophorone diisocyanate, methylene bis(4-cyclohexylisocyanate) (“HMDI”), the cyclo-trimer of 1,6-hexamethylene diisocyanate (also known as the isocyanurate trimer of HDI, commercially available as Desmodur N3300 from Covestro AG), and meta-tetramethylxylylene diisocyanate (commercially available as TMXDI® from Allnex SA). Aromatic polyisocyanates may include (i) arylene isocyanates, such as m-phenylene diisocyanate, p-phenylene diisocyanate, 1,5-naphthalene diisocyanate and 1,4-naphthalene diisocyanate, and (ii) alkarylene isocyanates, such as 4,4′-diphenylene methane (“MDI”), 2,4-tolylene or 2,6-tolylene diisocyanate (“TDI”), or mixtures thereof, 4,4-toluidine diisocyanate and xylylene diisocyanate. Triisocyanates, such as triphenyl methane-4,4′,4″-triisocyanate, 1,3,5-triisocyanato benzene and 2,4,6-triisocyanato toluene, tetraisocyanates, such as 4,4′-diphenyldimethyl methane-2.2′,5,5′-tetraisocyanate, and polymerized polyisocyanates, such as tolylene diisocyanate dimers and trimers and the like, may also be used. The curing agent may comprise a blocked polyisocyanate selected from a polymeric polyisocyanate, such as polymeric HDI, polymeric MDI, polymeric isophorone diisocyanate, and the like. The curing agent may also comprise a blocked trimer of hexamethylene diisocyanate available as Desmodur N3300® from Covestro AG. Mixtures of polyisocyanate curing agents may also be used.

The polyisocyanate curing agent may be at least partially blocked with at least one blocking agent selected from a 1,2-alkane diol, for example, 1,2-propanediol; a 1,3-alkane diol, for example, 1,3-butanediol; a benzylic alcohol, for example, benzyl alcohol; an allylic alcohol, for example, allyl alcohol; caprolactam; a dialkylamine, for example dibutylamine; and mixtures thereof. The polyisocyanate curing agent may be at least partially blocked with at least one 1,2-alkane diol having three or more carbon atoms, for example, 1,2-butanediol.

Other suitable blocking agents include aliphatic, cycloaliphatic, or aromatic alkyl monoalcohols or phenolic compounds, including, for example, lower aliphatic alcohols, such as methanol, ethanol, and n-butanol; cycloaliphatic alcohols, such as cyclohexanol; aromatic-alkyl alcohols, such as phenyl carbinol and methylphenyl carbinol; and phenolic compounds, such as phenol itself and substituted phenols wherein the substituents do not affect coating operations, such as cresol and nitrophenol. Glycol ethers and glycol amines may also be used as blocking agents. Suitable glycol ethers include ethylene glycol butyl ether, diethylene glycol butyl ether, ethylene glycol methyl ether and propylene glycol methyl ether. Other suitable blocking agents include oximes, such as methyl ethyl ketoxime, acetone oxime and cyclohexanone oxime.

The blocking agent may also comprise an alpha-hydroxy amide, ester or thioester. As used herein, the term “alpha-hydroxy amide” refers to an organic compound having at least one alpha-hydroxy amide moiety that includes a hydroxyl functional group covalently bonded to an alpha-carbon of an amide group. As used herein, the term “alpha-hydroxy ester” refers to an organic compound having at least one alpha-hydroxy ester moiety that includes a hydroxyl functional group covalently bonded to an alpha-carbon of an ester group. As used herein, the term “alpha-hydroxy thioester” refers to an organic compound having at least one alpha-hydroxy thioester moiety that includes a hydroxyl functional group covalently bonded to an alpha-carbon of a thioester group. The blocking agent comprising an alpha-hydroxy amide, ester or thioester may comprise a compound of structure (I):

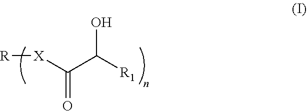

wherein X is N(R₂), O, S; n is 1 to 4; when n=1 and X=N(R₂), R is hydrogen, a C₁ to C₁₀ alkyl group, an aryl group, a polyether, a polyester, a polyurethane, a hydroxy-alkyl group, or a thio-alkyl group; when n=1 and X=O or S, R is a C₁ to C₁₀ alkyl group, an aryl group, a polyether, a polyester, a polyurethane, a hydroxy-alkyl group, or a thio-alkyl group; when n=2 to 4, R is a multi-valent C₁ to C₁₀ alkyl group, a multi-valent aryl group, a multi-valent polyether, a multi-valent polyester, a multi-valent polyurethane; each R₁ is independently hydrogen, a C₁ to C₁₀ alkyl group, an aryl group, or a cycloaliphatic group; each R₂ is independently hydrogen, a C₁ to C₁₀ alkyl group, an aryl group, a cycloaliphatic group, a hydroxy-alkyl group, or a thio-alkyl group; and R and R₂ together can form a cycloaliphatic, heterocyclic structure. The cycloaliphatic, heterocyclic structure may comprise, for example, morpholine, piperidine, or pyrrolidine. It should be noted that R can only be hydrogen if X is N(R₂). Specific examples of suitable alpha-hydroxy amide, ester, or thioester blocking agents are described in International Publication No. WO 2018/148306 A1, at par. [0012] to [0026], the cited portion of which is incorporated herein by reference.

The curing agent may comprise an aminoplast resin. Aminoplast resins are condensation products of an aldehyde with an amino- or amido-group carrying substance. Condensation products obtained from the reaction of alcohols and an aldehyde with melamine, urea or benzoguanamine may be used. However, condensation products of other amines and amides may also be employed, for example, aldehyde condensates of triazines, diazines, triazoles, guanidines, guanamines and alkyl- and aryl-substituted derivatives of such compounds, including alkyl- and aryl-substituted ureas and alkyl- and aryl-substituted melamines. Some examples of such compounds are N,N′-dimethyl urea, benzourea, dicyandiamide, formaguanamine, acetoguanamine, ammeline, 2-chloro-4,6-diamino-1,3,5-triazine, 6-methyl-2,4-diamino-1,3,5-triazine, 3,5-diaminotriazole, triaminopyrimidine, 2-mercapto-4,6-diaminopyrimidine, 3,4,6-tris(ethylamino)-1,3,5-triazine, and the like. Suitable aldehydes include formaldehyde, acetaldehyde, crotonaldehyde, acrolein, benzaldehyde, furfural, glyoxal and the like.

The aminoplast resins may contain methylol or similar alkylol groups, and at least a portion of these alkylol groups may be etherified by a reaction with an alcohol to provide organic solvent-soluble resins. Any monohydric alcohol may be employed for this purpose, including such alcohols as methanol, ethanol, propanol, butanol, pentanol, hexanol, heptanol and others, as well as benzyl alcohol and other aromatic alcohols, cyclic alcohol such as cyclohexanol, monoethers of glycols such as Cello solves and Carbitols, and halogen-substituted or other substituted alcohols, such as 3-chloropropanol and butoxyethanol.

Non-limiting examples of commercially available aminoplast resins are those available under the trademark CYMEL® from Allnex Belgium SA/NV, such as CYMEL 1130 and 1156, and RESIMENE® from INEOS Melamines, such as RESIMENE 750 and 753. Examples of suitable aminoplast resins also include those described in U.S. Pat. No. 3,937,679 at col. 16, line 3 to col. 17, line 47, this portion of which being hereby incorporated by reference. As is disclosed in the aforementioned portion of the '679 patent, the aminoplast may be used in combination with the methylol phenol ethers.

Phenoplast resins are formed by the condensation of an aldehyde and a phenol. Suitable aldehydes include formaldehyde and acetaldehyde. Methylene-releasing and aldehyde-releasing agents, such as paraformaldehyde and hexamethylene tetramine, may also be utilized as the aldehyde agent. Various phenols may be used, such as phenol itself, a cresol, or a substituted phenol in which a hydrocarbon radical having either a straight chain, a branched chain or a cyclic structure is substituted for a hydrogen in the aromatic ring. Mixtures of phenols may also be employed. Some specific examples of suitable phenols are p-phenylphenol, p-tert-butylphenol, p-tert-amylphenol, cyclopentylphenol and unsaturated hydrocarbon-substituted phenols, such as the monobutenyl phenols containing a butenyl group in ortho, meta or para position, and where the double bond occurs in various positions in the hydrocarbon chain.

Aminoplast and phenoplast resins, as described above, are described in U.S. Pat. No. 4,812,215 at co1.6, line 20 to col. 7, line 12, the cited portion of which being incorporated herein by reference.

The curing agent may optionally comprise a high molecular weight volatile group. As used herein, the term “high molecular weight volatile group” refers to blocking agents and other organic byproducts that are produced and volatilized during the curing reaction of the coating composition having a molecular weight of at least 70 g/mol, such as at least 125 g/mol, such as at least 160 g/mol, such as at least 195 g/mol, such as at least 400 g/mol, such as at least 700 g/mol, such as at least 1000 g/mol, or higher, and may range from 70 to 1,000 g/mol, such as 160 to 1,000 g/mol, such as 195 to 1,000 g/mol, such as 400 to 1,000 g/mol, such as 700 to 1,000 g/mol. For example, the organic byproducts may include alcoholic byproducts resulting from the reaction of the film-forming polymer and an aminoplast or phenoplast curing agent, and the blocking agents may include organic compounds, including alcohols, used to block isocyanato groups of polyisocyanates that are unblocked during cure. For clarity, the high molecular weight volatile groups are covalently bound to the curing agent prior to cure, and explicitly exclude any organic solvents that may be present in the coating composition. Upon curing, the pigment-to-binder ratio of the deposited film may increase in the cured film relative to deposited uncured pigment to binder ratio in the coating composition because of the loss of a higher mass of the blocking agents and other organic byproducts derived from the curing agent that are volatilized during cure. High molecular weight volatile groups may comprise 5% to 50% by weight of the film-forming binder, such as 7% to 45% by weight, such as 9% to 40% by weight, such as 11% to 35%, such as 13% to 30%, based on the total weight of the film-forming binder before cure. The high molecular weight volatile groups and other lower molecular weight volatile organic compounds produced during cure, such as lower molecular weight blocking agents and organic byproducts produced during cure, may be present in an amount such that the relative weight loss of the film-forming binder deposited onto the substrate relative to the weight of the film-forming binder after cure is an amount of 5% to 50% by weight of the film-forming binder, such as 7% to 45% by weight, such as 9% to 40% by weight, such as 11% to 35%, such as 13% to 30%, based on the total weight of the film-forming binder before and after cure.

The curing agent may be present in the cationic electrodepositable coating composition in an amount of at least 10% by weight, such as at least 20% by weight, such as at least 25% by weight, and may be present in an amount of no more than 60% by weight, such as no more than 50% by weight, such as no more than 40% by weight, based on the total weight of the resin solids of the electrodepositable coating composition. The curing agent may be present in the cationic electrodepositable coating composition in an amount of 10% to 60% by weight, such as 20% to 50% by weight, such as 25% to 40% by weight, based on the total weight of the resin solids of the electrodepositable coating composition.

The curing agent may be present in the anionic electrodepositable coating composition in an amount of at least 10% by weight, such as at least 20% by weight, such as at least 25% by weight, and may be present in an amount of no more than 50% by weight, such as no more than 45% by weight, such as no more than 40% by weight, based on the total weight of the resin solids of the electrodepositable coating composition. The curing agent may be present in the anionic electrodepositable coating composition in an amount of 10% to 50% by weight, such as 20% to 45% by weight, such as 25% to 40% by weight, based on the total weight of the resin solids of the electrodepositable coating composition.

According to the present disclosure, the film-forming binder component of the spray-applied coating composition may further comprise a curing agent (b). Suitable curing agents (b) for use in the film-forming binder component of the coating compositions of the present disclosure include aminoplasts, polyisocyanates, including blocked isocyanates, polyepoxides, beta-hydroxyalkylamides, polyacids, organometallic acid-functional materials, polyamines, polyamides, polysulfides, polythiols, polyenes such as polyacrylates, polyols, polysilanes and mixtures of any of the foregoing, and include those known in the art for any of these materials. The terms “curing agent” “crosslinking agent” and “crosslinker” are herein used interchangeably.

Useful aminoplasts can be obtained from the condensation reaction of formaldehyde with an amine or amide. Nonlimiting examples of amines or amides include melamine, urea and benzoguanamine.

Although condensation products obtained from the reaction of alcohols and formaldehyde with melamine, urea or benzoguanamine are most common, condensates with other amines or amides can be used. Formaldehyde is the most commonly used aldehyde, but other aldehydes such as acetaldehyde, crotonaldehyde, and benzaldehyde can also be used.

The aminoplast can contain imino and methylol groups. In certain instances, at least a portion of the methylol groups can be etherified with an alcohol to modify the cure response. Any monohydric alcohol like methanol, ethanol, n-butyl alcohol, isobutanol, and hexanol can be employed for this purpose. Nonlimiting examples of suitable aminoplast resins are commercially available from Allnex, under the trademark CYMEL and from INEOS under the trademark RESIMENE.

Other crosslinking agents suitable for use include polyisocyanate crosslinking agents. As used herein, the term “polyisocyanate” is intended to include blocked (or capped) polyisocyanates as well as unblocked polyisocyanates. The polyisocyanate can be aliphatic, aromatic, or a mixture thereof. Although higher polyisocyanates such as isocyanurates of diisocyanates are often used, diisocyanates can also be used. Isocyanate prepolymers, for example reaction products of polyisocyanates with polyols also can be used. Mixtures of polyisocyanate crosslinking agents can be used.

The polyisocyanate can be prepared from a variety of isocyanate-containing materials. Examples of suitable polyisocyanates include trimers prepared from the following diisocyanates: toluene diisocyanate, 4,4′-methylene-bis(cyclohexyl isocyanate), isophorone diisocyanate, an isomeric mixture of 2,2,4- and 2,4,4-trimethyl hexamethylene diisocyanate, 1,6-hexamethylene diisocyanate, tetramethyl xylylene diisocyanate and 4,4′-diphenylmethylene diisocyanate. In addition, blocked polyisocyanate prepolymers of various polyols such as polyester polyols can also be used.

Isocyanate groups may be capped or uncapped as desired. If the polyisocyanate is to be blocked or capped, any suitable aliphatic, cycloaliphatic, or aromatic alkyl monoalcohol or phenolic compound known to those skilled in the art can be used as a capping agent for the polyisocyanate. Examples of suitable blocking agents include those materials which would unblock at elevated temperatures such as lower aliphatic alcohols including methanol, ethanol, and n-butanol; cycloaliphatic alcohols such as cyclohexanol; aromatic-alkyl alcohols such as phenyl carbinol and methylphenyl carbinol; and phenolic compounds such as phenol itself and substituted phenols wherein the substituents do not affect coating operations, such as cresol and nitrophenol. Glycol ethers may also be used as capping agents. Suitable glycol ethers include ethylene glycol butyl ether, diethylene glycol butyl ether, ethylene glycol methyl ether and propylene glycol methyl ether. Other suitable capping agents include oximes such as methyl ethyl ketoxime, acetone oxime and cyclohexanone oxime, lactams such as epsilon-caprolactam, pyrazoles such as dimethyl pyrazole, and amines such as dibutyl amine, butyl glycol amide, and butyl lactamide.

The crosslinking agent may optionally comprise a high molecular weight volatile group as defined above. These may be the same as discussed above. High molecular weight volatile groups may comprise 5% to 50% by weight of the film-forming binder, such as 7% to 45% by weight, such as 9% to 40% by weight, such as 11% to 35%, such as 13% to 30%, based on the total weight of the organic film-forming binder. The high molecular weight volatile groups and other lower molecular weight volatile organic compounds produced during cure, such as lower molecular weight blocking agents and organic byproducts produced during cure, may be present in an amount such that the relative weight loss of the organic film-forming binder deposited onto the substrate relative to the weight of the organic film-forming binder after cure is an amount of 5% to 50% by weight of the organic film-forming binder, such as 7% to 45% by weight, such as 9% to 40% by weight, such as 11% to 35%, such as 13% to 30%, based on the total weight of the organic film-forming binder before cure.

Polyepoxides are suitable curing agents for polymers having carboxylic acid groups and/or amine groups. Examples of suitable polyepoxides include low molecular weight polyepoxides such as 3,4-epoxycyclohexylmethyl 3,4-epoxycyclohexanecarboxylate and bis(3,4-epoxy-6-methylcyclohexyl-methyl) adipate. Higher molecular weight polyepoxides, including the polyglycidyl ethers of polyhydric phenols and alcohols described above, are also suitable as crosslinking agents.

Beta-hydroxyalkylamides are suitable curing agents for polymers having carboxylic acid groups. The beta-hydroxyalkylamides can be depicted structurally as follows:

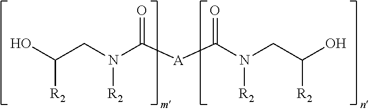

wherein each R₂ is hydrogen or lower alkyl containing from 1 to 5 carbon atoms including mixed substituents or:

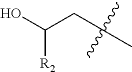

wherein R₂ is hydrogen or lower alkyl containing from 1 to 5 carbon atoms including mixed substituents; A is a bond or a polyvalent organic radical derived from a saturated, unsaturated, or aromatic hydrocarbon including substituted hydrocarbon radicals containing from 2 to 20 carbon atoms; m′ is equal to 1 or 2; n′ is equal to 0 or 2, and m′+n′ is at least 2, usually within the range of from 2 up to and including 4. Most often, A is a C₂ to C₁₂ divalent alkylene radical.

Polyacids, particularly polycarboxylic acids, are suitable curing agents for polymers having epoxy functional groups. Examples of suitable polycarboxylic acids include adipic, succinic, sebacic, azelaic, and dodecanedioic acid. Other suitable polyacid crosslinking agents include acid group-containing acrylic polymers prepared from an ethylenically unsaturated monomer containing at least one carboxylic acid group and at least one ethylenically unsaturated monomer that is free from carboxylic acid groups. Such acid functional acrylic polymers can have an acid equivalent weight ranging from 100 to 2,000 g/mol, based on the total solid weight of the acid functional acrylic polymers. Acid functional group-containing polyesters can be used as well. Low molecular weight polyesters and half-acid esters can be used that are based on the condensation of aliphatic polyols with aliphatic and/or aromatic polycarboxylic acids or anhydrides. Examples of suitable aliphatic polyols include ethylene glycol, propylene glycol, butylene glycol, 1,6-hexanediol, trimethylol propane, di-trimethylol propane, neopentyl glycol, 1,4-cyclohexanedimethanol, pentaerythritol, and the like. The polycarboxylic acids and anhydrides may include, inter alia, terephthalic acid, isophthalic acid, phthalic acid, phthalic anhydride, tetrahydrophthalic acid, tetrahydrophthalic anhydride, hexahydrophthalic anhydride, methylhexahydrophthalic anhydride, chlorendic anhydride, and the like. Mixtures of acids and/or anhydrides may also be used. The above-described polyacid crosslinking agents are described in further detail in U.S. Pat. No. 4,681,811, at column 6, line 45 to column 9, line 54, the cited portion of which is incorporated herein by reference.

Nonlimiting examples of suitable polyamine crosslinking agents include primary or secondary diamines or polyamines in which the radicals attached to the nitrogen atoms can be saturated or unsaturated, aliphatic, alicyclic, aromatic, aromatic-substituted-aliphatic, aliphatic-substituted-aromatic, and heterocyclic. Nonlimiting examples of suitable aliphatic and alicyclic diamines include 1,2-ethylene diamine, 1,2-propylene diamine, 1,8-octane diamine, isophorone diamine, propane-2,2-cyclohexyl amine, and the like. Nonlimiting examples of suitable aromatic diamines include phenylene diamines and toluene diamines, for example o-phenylene diamine and p-tolylene diamine. Polynuclear aromatic diamines such as 4,4′-biphenyl diamine, methylene dianiline and monochloromethylene dianiline are also suitable.

Examples of suitable aliphatic diamines include, without limitation, ethylene diamine, 1,2-diaminopropane, 1,4-diaminobutane, 1,3-diaminopentane, 1,5-diaminopentane, 1,6-diaminohexane, 2-methyl-1,5-pentane diamine, 2,5-diamino-2,5-dimethylhexane, 2,2,4- and/or 2,4,4-trimethyl-1,6-diamino-hexane, 1,11-diaminoundecane, 1,12-diaminododecane, 1,3- and/or 1,4-cyclohexane diamine, 1-amino-3,3,5-trimethyl-5-aminomethyl-cyclohexane, 2,4- and/or 2,6-hexahydrotoluylene diamine, 2,4′- and/or 4,4′-diamino-dicyclohexyl methane and 3,3′-dialkyl4,4′-diamino-dicyclohexyl methanes (such as 3,3′-dimethyl-4,4′-diamino-dicyclohexyl methane and 3,3′-diethyl-4,4′-diamino-dicyclohexyl methane), 2,4- and/or 2,6-diaminotoluene and 2,4′- and/or 4,4′-diaminodiphenyl methane, or mixtures thereof. Cycloaliphatic diamines are available commercially from Huntsman Corporation (Houston, TX) under the designation of JEFFLINK such as JEFFLINK 754. Additional aliphatic cyclic polyamines may also be used, such as DESMOPHEN NH 1520 available from Covestro and/or CLEARLINK 1000, which is a secondary aliphatic diamine available from Dorf Ketal. POLYCLEAR 136 (available from BASF/Hansen Group LLC), the reaction product of isophorone diamine and acrylonitrile, is also suitable. Other exemplary suitable polyamines are described in U.S. Pat. No. 4,046,729 at column 6, line 61 to column 7, line 26, and in U.S. Pat. No. 3,799,854 at column 3, lines 13 to 50, the cited portions of which are incorporated by reference herein. Additional polyamines may also be used, such as ANCAMINE polyamines, available from Evonik.

Suitable polyamides include any of those known in the art. For example, ANCAMIDE polyamides, available from Evonik.

Suitable polyenes may include those that are represented by the formula:

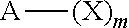

wherein A is an organic moiety, X is an olefinically unsaturated moiety and m is at least 2, typically 2 to 6. Examples of X are groups of the following structure:

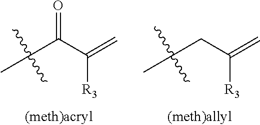

wherein each R₃ is a radical selected from H and methyl.

The polyenes may be compounds or polymers having in the molecule olefinic double bonds that are polymerizable by exposure to radiation. Examples of such materials are (meth)acrylic-functional (meth)acrylic copolymers, epoxy resin (meth)acrylates, polyester (meth)acrylates, polyether (meth)acrylates, polyurethane (meth)acrylates, amino (meth)acrylates, silicone (meth)acrylates, and melamine (meth)acrylates. The number average molar mass (Mn) of these compounds is often 200 to 10,000 g/mol as determined by GPC using polystyrene as a standard. The molecule often contains on average 2 to 20 olefinic double bonds that are polymerizable by exposure to radiation. Aliphatic and/or cycloaliphatic (meth)acrylates in each case are often used. (Cyclo)aliphatic polyurethane (meth)acrylates and (cyclo)aliphatic polyester (meth)acrylates are particularly suitable. The binders may be used singly or in mixture.

Specific examples of polyurethane (meth)acrylates are reaction products of the polyisocyanates such as 1,6-hexamethylene diisocyanate and/or isophorone diisocyanate including isocyanurate and biuret derivatives thereof with hydroxyalkyl (meth)acrylates such as hydroxyethyl (meth)acrylate and/or hydroxypropyl (meth)acrylate. The polyisocyanate can be reacted with the hydroxyalkyl (meth)acrylate in a 1:1 equivalent ratio or can be reacted with an NCO/OH equivalent ratio greater than 1 to form an NCO-containing reaction product that can then be chain extended with a polyol such as a diol or triol, for example, 1,4-butane diol, 1,6-hexane diol and/or trimethylol propane. Examples of polyester (meth)acrylates are the reaction products of (meth)acrylic acid or anhydride with polyols, such as diols, triols and tetrols, including alkylated polyols, such as propoxylated diols and triols. Examples of polyols include 1,4-butane diol, 1,6-hexane diol, neopentyl glycol, trimethylol propane, pentaerythritol and propoxylated 1,6-hexane diol. Specific examples of polyester (meth)acrylate are glycerol tri(meth)acrylate, trimethylolpropane tri(meth)acrylate, pentaerythritol tri(meth)acrylate and pentaerythritol tetra(meth)acrylate.

Besides (meth)acrylates, (meth)allyl compounds or polymers can be used either alone or in combination with (meth)acrylates. Examples of (meth)allyl materials are polyallyl ethers such as the diallyl ether of 1,4-butane diol and the triallyl ether of trimethylol propane. Examples of other (meth)allyl materials are polyurethanes containing (meth)allyl groups. For example, reaction products of the polyisocyanates such as 1,6-hexamethylene diisocyanate and/or isophorone diisocyanate including isocyanurate and biuret derivatives thereof with hydroxyl-functional allyl ethers, such as the monoallyl ether of 1,4-butane diol and the diallylether of trimethylol propane. The polyisocyanate can be reacted with the hydroxyl-functional allyl ether in a 1:1 equivalent ratio or can be reacted with an NCO/OH equivalent ratio greater than 1 to form an NCO-containing reaction product that can then be chain extended with a polyol such as a diol or triol, for example, 1,4-butane diol, 1,6-hexane diol and/or trimethylol propane.

As used herein the term “polythiol functional material” refers to polyfunctional materials containing two or more thiol functional groups (SH). Suitable polythiol functional materials for use in forming the curable film-forming composition are numerous and can vary widely. Such polythiol functional materials can include those that are known in the art. Non-limiting examples of suitable polythiol functional materials can include polythiols having at least two thiol groups including compounds and polymers. The polythiol can have ether linkages (—O—), sulfide linkages (—S—), including polysulfide linkages (—Sₓ—), wherein x is at least 2, such as from 2 to 4, and combinations of such linkages.

The polythiols for use in the present disclosure include materials of the formula:

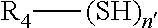

wherein R₄ is a polyvalent organic moiety and n′ is an integer of at least 2, typically 2 to 6.

Non-limiting examples of suitable polythiols include esters of thiol-containing acids of the formula HS—R₅—COOH wherein R₅ is an organic moiety with polyhydroxy compounds of the structure R₆—(OH)ₙ, wherein R₆ is an organic moiety and n′ is at least 2, typically 2 to 6. These components can be reacted under suitable conditions to give polythiols having the general structure:

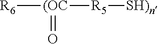

wherein R₅, R₆ and n′ are as defined above.

Examples of thiol-containing acids are thioglycolic acid (HS—CH₂COOH), α-mercaptopropionic acid (HS—CH(CH₃)—COOH) and β-mercaptopropionic acid (HS—CH₂CH₂COOH) with polyhydroxy compounds such as glycols, triols, tetrols, pentaols, hexaols, and mixtures thereof. Other non-limiting examples of suitable polythiols include ethylene glycol bis (thioglycolate), ethylene glycol bis(ß-mercaptopropionate), trimethylolpropane tris (thioglycolate), trimethylolpropane tris (β-mercaptopropionate), pentaerythritol tetrakis (thioglycolate) and pentaerythritol tetrakis (β-mercaptopropionate), and mixtures thereof.

Suitable polyacids and polyols useful as curing agents include any of those known in the art, such as those described herein for the making of polyesters.

Appropriate mixtures of crosslinking agents may also be used in the disclosure.

The amount of curing agent (b) in the curable film-forming composition generally ranges from 5 to 75% by weight, based on the total weight of resin solids in the curable film-forming composition. For example, the minimum amount of crosslinking agent may be at least 5% by weight, often at least 10% by weight and more often, at least 15% by weight, based on the total weight of resin solids in the curable film-forming composition. The maximum amount of crosslinking agent may be 75% by weight, more often 60% by weight, or 50% by weight, based on the total weight of resin solids in the curable film-forming composition. Ranges of crosslinking agent may include, for example, 5 to 50% by weight, 5 to 60% by weight, 5% to 75% by weight, 10 to 50% by weight, 10 to 60% by weight, 10 to 75% by weight, 15 to 50% by weight, 15 to 60% by weight, and 15 to 75% by weight, based on the total weight of resin solids in the curable film-forming composition.

The resin component (a) may comprise epoxide functional groups and the curing agent component (b) may comprise amine functional groups. For example, the coating composition may comprise, consist essentially of, or consist of a film-forming binder comprising a resin component comprising epoxide functional groups, curing agent comprising amine functional groups, an organic solvent, and at least one of the corrosion inhibitors discussed above.

The coatings compositions used to form the conformal coating of the present disclosure may comprise additional optional components.

For example, the electrodepositable coating compositions may optionally comprise one or more further components in addition to the ionic salt group-containing film-forming polymer and the curing agent described above.

According to the present disclosure, the electrodepositable coating composition may optionally comprise a catalyst to catalyze the reaction between the curing agent and the polymers. Examples of catalysts suitable for cationic electrodepositable coating compositions include, without limitation, organotin compounds (e.g., dibutyltin oxide and dioctyltin oxide) and salts thereof (e.g., dibutyltin diacetate); other metal oxides (e.g., oxides of cerium, zirconium and bismuth) and salts thereof (e.g., bismuth sulfamate and bismuth lactate); or a cyclic guanidine as described in U.S. Pat. No. 7,842,762 at col. 1, line 53 to col. 4, line 18 and col. 16, line 62 to col. 19, line 8, the cited portions of which being incorporated herein by reference. Examples of catalysts suitable for anionic electrodepositable coating compositions include latent acid catalysts, specific examples of which are identified in WO 2007/118024 at and include, but are not limited to, ammonium hexafluoroantimonate, quaternary salts of SbF₆ (e.g., NACURE® XC-7231), t-amine salts of SbF₆ (e.g., NACURE® XC-9223), Zn salts of triflic acid (e.g., NACURE® A202 and A218), quaternary salts of triflic acid (e.g., NACURE® XC-A230), and diethylamine salts of triflic acid (e.g., NACURE® A233), all commercially available from King Industries, and/or mixtures thereof. Latent acid catalysts may be formed by preparing a derivative of an acid catalyst such as para-toluenesulfonic acid (pTSA) or other sulfonic acids. For example, a well-known group of blocked acid catalysts are amine salts of aromatic sulfonic acids, such as pyridinium para-toluenesulfonate. Such sulfonate salts are less active than the free acid in promoting crosslinking. During cure, the catalysts may be activated by heating.

According to the present disclosure, the electrodepositable coating composition may comprise other optional ingredients, such as a pigment composition and, if desired, various additives such as fillers, plasticizers, anti-oxidants, biocides, UV light absorbers and stabilizers, hindered amine light stabilizers, defoamers, fungicides, dispersing aids, flow control agents, surfactants, wetting agents, or combinations thereof. Alternatively, the electrodepositable coating composition may be completely free of any of the optional ingredients, i.e., the optional ingredient is not present in the electrodepositable coating composition. The pigment composition may comprise, for example, iron oxides, lead oxides, strontium chromate, carbon black, coal dust, titanium dioxide, talc, barium sulfate, as well as color pigments such as cadmium yellow, cadmium red, chromium yellow and the like. The pigment content of the dispersion may be expressed as the pigment-to-resin weight ratio, and may be within the range of 0.03 to 0.6, when pigment is used. The other additives mentioned above may be present in the electrodepositable coating composition in amounts of 0.01% to 3% by weight, based on total weight of the resin solids of the electrodepositable coating composition.

According to the present disclosure, the electrodepositable coating composition may comprise water and/or one or more organic solvent(s). Water can for example be present in amounts of 40% to 90% by weight, such as 50% to 75% by weight, based on total weight of the electrodepositable coating composition. Examples of suitable organic solvents include oxygenated organic solvents, such as monoalkyl ethers of ethylene glycol, diethylene glycol, propylene glycol, and dipropylene glycol which contain from 1 to 10 carbon atoms in the alkyl group, such as the monoethyl and monobutyl ethers of these glycols. Examples of other at least partially water-miscible solvents include alcohols such as ethanol, isopropanol, butanol and diacetone alcohol. If used, the organic solvents may typically be present in an amount of less than 10% by weight, such as less than 5% by weight, based on total weight of the electrodepositable coating composition. The electrodepositable coating composition may in particular be provided in the form of a dispersion, such as an aqueous dispersion.

According to the present disclosure, the total solids content of the electrodepositable coating composition may be at least 1% by weight, such as at least 5% by weight, and may be no more than 50% by weight, such as no more than 40% by weight, such as no more than 20% by weight, based on the total weight of the electrodepositable coating composition. The total solids content of the electrodepositable coating composition may be from 1% to 50% by weight, such as 5% to 40% by weight, such as 5% to 20% by weight, based on the total weight of the electrodepositable coating composition. As used herein, “total solids” refers to the non-volatile content of the electrodepositable coating composition, i.e., materials which will not volatilize when heated to 110° C. for 15 minutes.

The non-electrodepositable coating composition used to form the conformal coating of the present disclosure may optionally comprise one or more further components in addition to the organic resin component, and the curing agent component.

A suitable corrosion inhibitor that could be used is magnesium oxide (MgO). Any MgO of any number average particle size can be used according to the present disclosure. The number average particle size may be determined by visually examining a micrograph of a transmission electron microscopy (“TEM”) image as described below. For example, the MgO may be micron sized, such as 0.5 to 50 microns or 1 to 15 microns, with size based on average particle size. Alternatively, or in addition, the MgO may be nano sized, such as 10 to 499 nanometers, or 10 to 100 nanometers, with size based on number average particle size. It will be appreciated that these particle sizes refer to the particle size of the MgO at the time of incorporation into the curable film-forming composition. Various coating preparation methods may result in the MgO particles agglomerating, which could increase average particle size, or shearing or other action that can reduce average particle size. MgO is commercially available from a number of sources.

Ultrafine MgO particles may be used in the corrosion inhibitor (2). As used herein, the term “ultrafine” refers to particles that have a B.E.T. specific surface area of at least 10 square meters per gram, such as 30 to 500 square meters per gram, or, in some cases, 80 to 250 square meters per gram. As used herein, the term “B.E.T. specific surface area” refers to a specific surface area determined by nitrogen adsorption according to the ASTMD 3663-78 standard based on the Brunauer-Emmett-Teller method described in the periodical “The Journal of the American Chemical Society”, 60, 309 (1938).

The curable film-forming compositions of the present disclosure may comprise MgO particles having a calculated equivalent spherical diameter of no more than 200 nanometers, such as no more than 100 nanometers, or, for example, 5 to 50 nanometers. As will be understood by those skilled in the art, a calculated equivalent spherical diameter can be determined from the B.E.T. specific surface area according to the following equation: Diameter (nanometers)=6000/[BET (m²/g)*density p (grams/cm³)].

Often the MgO particles have a number average primary particle size of no more than 100 nanometers, such as no more than 50 nanometers, or no more than 25 nanometers, as determined by visually examining a micrograph of a transmission electron microscopy (“TEM”) image, measuring the diameter of the particles in the image, and calculating the average primary particle size of the measured particles based on magnification of the TEM image. One of ordinary skill in the art will understand how to prepare such a TEM image and determine the primary particle size based on the magnification. The primary particle size of a particle refers to the smallest diameter sphere that will completely enclose the particle. As used herein, the term “primary particle size” refers to the size of an individual particle as opposed to an agglomeration of two or more individual particles.

The shape (or morphology) of the MgO particles can vary. For example, generally spherical morphologies can be used, as well as particles that are cubic, platy, polyhedric, or acicular (elongated or fibrous). The particles may be covered completely in a polymeric gel, not covered at all in a polymeric gel, or covered partially with a polymeric gel. Covered partially with a polymeric gel means that at least some portion of the particle has a polymeric gel deposited thereon, which, for example, may be covalently bonded to the particle or merely associated with the particle.

The amount of MgO, if used in the curable film-forming composition, can vary. For example, the curable film-forming composition can comprise 1 to 50 percent by weight MgO particles, with minimums, for example, of 1 percent by weight, or 5 percent by weight, or 10 percent by weight, and maximums of 50 percent by weight, or 40 percent by weight. Exemplary ranges include 5 to 50 percent by weight, 5 to 40 percent by weight, 10 to 50 percent by weight and 10 to 40 percent by weight, with percent by weight based on the total weight of all solids, including pigments, in the curable film-forming composition. The amount of MgO, if used, may be higher than the amount of any other corrosion inhibitor used in the composition, such as higher than any other inorganic corrosion inhibitor and/or any other polysulfide corrosion inhibitor, and may be higher than any corrosion inhibitor that is in an adjacent coating layer (if any are present).

Amino acid(s) are also suitable additional corrosion inhibitors according to the present disclosure. Amino acids will be understood by those skilled in the art as compounds having both acid and amine functionality, with side chains specific to each amino acid. The amino acid may be monomeric or oligomeric, including a dimer. When an oligomeric amino acid is used, the molecular weight, as determined by GPC, of the oligomer is often less than 1000.

Non-limiting examples of amino acids include histidine, arginine, lysine, cysteine, cystine, tryptophan, methionine, phenylalanine and tyrosine. Mixtures may also be used. The amino acids can be either L- or D-enantiomers, which are mirror images of each other, or mixtures thereof. The L-configurations are typically found in proteins and nature and as such are widely commercially available. The term “amino acids” as used herein therefore refers to both the D- and L-configurations; it is foreseen that only the L- or only the D-configuration may be included. Amino acids can be purchased, for example, from Sigma Aldrich, Thermo Fisher Scientific, Hawkins Pharmaceutical, or Ajinomato. Often the amino acids glycine, arginine, proline, cysteine and/or methionine may be specifically excluded.

The amino acid can be present in any amount that improves the corrosion resistance of the coating. For example, the amino acid may be present in an amount of 0.1 to 20 percent by weight, such as at least 0.1 percent by weight or at least 2 percent by weight and at most 20 percent by weight or at most 4 percent by weight; exemplary ranges include 0.1 to 4 percent by weight, 2 to 4 percent by weight, or 2 to 20 percent by weight, based on the total weight of resin solids in the curable film-forming composition.

An azole may also be a suitable additional corrosion inhibitor. Examples of suitable azoles include benzotriazoles such as 5-methyl benzotriazole, tolyltriazole, 2,5-dimercapto-1,3,4-thiadiazole, 2-mercaptobenzothiazole, 2-mercaptobenzimidazole, 1-phenyl-5-mercaptotetrazole, 2-amino-5-mercapto-1,3,4-thiadiazole, 2-mercapto-1-methylimidazole, 2-amino-5-ethyl-1,3,4-thiadiazole, 2-amino-5-ethylthio-1,3,4-thiadiazole, 5-phenyltetrazole, 7H-imidazo[4,5-d]pyrimidine, and 2-amino thiazole. Salts of any of the foregoing, such as sodium and/or zinc salts, are also suitable. Additional azoles include 2-hydroxybenzothiazole, benzothiazole, 1-phenyl-4-methylimidazole, and 1-(p-tolyl)-4-methlyimidazole. A suitable azole-containing product is commercially available from WPC Technologies, as HYBRICOR 204, Hybricor 204S, and Inhibicor 1000. Mixtures of azoles may also be used. Typically, the azole is present in the curable film-forming composition, if used, in amounts as low as 0.1 percent, such as 0.1 to 25 percent by weight, based on total weight of resin solids in the curable film-forming composition.

Lithium-based compounds are also another suitable additional corrosion inhibitor. Lithium-based compounds can be used, for example, in salt form, such as an organic or inorganic salt. Examples of suitable lithium salts include but are not limited to lithium carbonate, lithium phosphate, lithium sulphate, and lithium tetraborate. Other lithium compounds include but are not limited to lithium silicate including lithium orthosilicate (Li₄SiO₄), lithium metasilicate (LizSiO₃), lithium zirconate, and lithium-exchanged silica particles. Curable film-forming compositions of the present disclosure may also exclude lithium compounds, such as lithium salt and/or lithium silicate; that is the coating compositions of the present disclosure may be substantially free of any of the lithium compounds described above. As used in this context, substantially free means the lithium compound, if present at all, is only present in trace amounts, such as less than 0.1 weight percent of lithium based on the total solid weight of the coating composition. If used, a lithium compound can be used in amounts of 0.1 to 4.5 percent of lithium by weight, based on the total weight of resin solids in the curable film-forming composition.

The curable film-forming compositions of the present disclosure, comprising (1) a curable, organic film-forming binder component (i.e., (a) a resin component and (b) a curing agent component) and (2) a corrosion inhibitor comprising the polysulfide corrosion inhibitor, may be provided and stored as one-package compositions prior to use. A one-package composition will be understood as referring to a composition wherein all the coating components are maintained in the same container after manufacture, during storage, etc. A typical one-package coating can be applied to a substrate and cured by any conventional means, such as by heating, forced air, radiation cure and the like. For some coatings, such as ambient cure coatings, it is not practical to store them as a one-package, but rather they must be stored as multi-package coatings to prevent the components from curing prior to use. The term “multi-package coatings” means coatings in which various components are maintained separately until just prior to application. The present coatings can also be multi-package coatings, such as a two-package coating.

Thus, the components (a) and (b) may be provided as a one-package (1K) or multi-package, such as a two-package (2K) system. The components of the organic film-forming binder (1) are often provided in separate packages and mixed together immediately prior to the reaction. When the reaction mixture is a multi-package system, the corrosion inhibitor (2) may be present in either one or both of the separate components (a) and (b) and/or as an additional separate component package.

The curable film-forming composition of the present disclosure may additionally include optional ingredients commonly used in such compositions. For example, the composition may further comprise a hindered amine light stabilizer for UV degradation resistance. Such hindered amine light stabilizers include those disclosed in U.S. Pat. No. 5,260,135. When they are used, they are typically present in the composition in an amount of 0.1 to 2 percent by weight, based on the total weight of resin solids in the film-forming composition. Other optional additives may be included such as colorants, plasticizers, abrasion-resistant particles, film strengthening particles, flow control agents, thixotropic agents, rheology modifiers, fillers, catalysts, antioxidants, biocides, defoamers, surfactants, wetting agents, dispersing aids, adhesion promoters, UV light absorbers and stabilizers, a stabilizing agent, organic cosolvents, reactive diluents, grind vehicles, and other customary auxiliaries, or combinations thereof. The term “colorant”, as used herein is as defined in U.S. Patent Publication No. 2012/0149820, paragraphs 29 to 38, the cited portion of which is incorporated herein by reference.

An “abrasion-resistant particle” is one that, when used in a coating, will impart some level of abrasion resistance to the coating as compared with the same coating lacking the particles. Suitable abrasion-resistant particles include organic and/or inorganic particles. Examples of suitable organic particles include, but are not limited to, diamond particles, such as diamond dust particles, and particles formed from carbide materials; examples of carbide particles include, but are not limited to, titanium carbide, silicon carbide and boron carbide. Examples of suitable inorganic particles, include but are not limited to silica; alumina; alumina silicate; silica alumina; alkali aluminosilicate; borosilicate glass; nitrides including boron nitride and silicon nitride; oxides including titanium dioxide and zinc oxide; quartz; nepheline syenite; zirconium such as in the form of zirconium oxide; baddeleyite; and cudialyte. Particles of any size can be used, as can mixtures of different particles and/or different sized particles.

The coating compositions of the present disclosure may also comprise, in addition to any of the previously described corrosion inhibiting compounds, any other corrosion resisting particles including, but are not limited to, iron phosphate, zinc phosphate, calcium ion-exchanged silica, colloidal silica, synthetic amorphous silica, and molybdates, such as calcium molybdate, zinc molybdate, barium molybdate, strontium molybdate, and mixtures thereof. Suitable calcium ion-exchanged silica is commercially available from W. R. Grace & Co. as SHIELDEX AC3 and/or SHIELDEX C303. Suitable amorphous silica is available from W. R. Grace & Co. as SYLOID. Suitable zinc hydroxyl phosphate is commercially available from Elementis Specialties, Inc. as NALZIN. 2. These particles, if used, may be present in the compositions of the present disclosure in an amount ranging from 5 to 40 percent by weight, such as at least 5 percent by weight or at least 10 percent by weight, and at most 40 percent by weight or at most 25 percent by weight, with ranges such as 10 to 25 percent by weight, with the percentages by weight being based on the total solids weight of the composition.

The curable film-forming compositions of the present disclosure may comprise one or more solvents including water and/or organic solvents. Suitable organic solvents include glycols, glycol ether alcohols, alcohols, ketones, and aromatics, such as xylene and toluene, acetates, mineral spirits, naphthas and/or mixtures thereof. “Acetates” include the glycol ether acetates. The solvent can be a non-aqueous solvent. “Non-aqueous solvent” and like terms means that less than 50 wt % of the solvent is water. For example, less than 10 wt %, or even less than 5 wt % or 2 wt %, of the solvent can be water. It will be understood that mixtures of solvents, including water in an amount of less than 50 wt % or containing no water, can constitute a “non-aqueous solvent”. The composition may be aqueous or water-based. This means that more than 50 wt % of the solvent is water. Such compositions have less than 50 wt %, such as less than 20 wt %, less than 10 wt %, less than 5 wt % or less than 2 wt % of organic solvent(s).

The metal substrate may be coated by any suitable technique. For example, the method may comprise electrophoretically applying an electrodepositable coating composition as described above to the substrate and curing the coating composition to form an at least partially cured coating on the substrate. The method may comprise (a) electrophoretically depositing onto the substrate an electrodepositable coating composition and (b) heating the coated substrate to a temperature and for a time sufficient to cure the electrodeposited coating on the substrate.

A cationic electrodepositable coating composition may be deposited upon an electrically conductive substrate by placing the composition in contact with an electrically conductive cathode and an electrically conductive anode, with the surface to be coated being the cathode. Following contact with the composition, an adherent film of the coating composition is deposited on the cathode when a sufficient voltage is impressed between the electrodes. The conditions under which the electrodeposition is carried out are, in general, similar to those used in electrodeposition of other types of coatings. The applied voltage may be varied and can be, for example, as low as one volt to as high as several thousand volts, such as between 50 and 500 volts. The current density may be between 0.5 ampere and 15 amperes per square foot and tends to decrease during electrodeposition indicating the formation of an insulating film.

Once the cationic electrodepositable coating composition is electrodeposited over the metal substrate, the coated substrate is heated to a temperature and for a time sufficient to at least partially cure the electrodeposited coating on the substrate. As used herein, the term “at least partially cured” with respect to a coating refers to a coating formed by subjecting the coating composition to curing conditions such that a chemical reaction of at least a portion of the reactive groups of the components of the coating composition occurs to form a coating. The coated substrate may be heated to a temperature ranging from 250° F. to 450° F. (121.1° C. to 232.2° C.), such as from 275° F. to 400° F. (135° ° C. to 204.4° C.), such as from 300° F. to 360° F. (149° C. to 180° C.). The curing time may be dependent upon the curing temperature as well as other variables, for example, the film thickness of the electrodeposited coating, level and type of catalyst present in the composition and the like. For example, the curing time can range from 10 minutes to 60 minutes, such as 20 to 40 minutes.

An anionic electrodepositable coating composition may be deposited upon the metal substrate by placing the composition in contact with an electrically conductive cathode and an electrically conductive anode, with the surface to be coated being the anode. Following contact with the composition, an adherent film of the coating composition is deposited on the anode when a sufficient voltage is impressed between the electrodes. The conditions under which the electrodeposition is carried out are, in general, similar to those used in electrodeposition of other types of coatings. The applied voltage may be varied and can be, for example, as low as one volt to as high as several thousand volts, such as between 50 and 500 volts. The current density may be between 0.5 ampere and 15 amperes per square foot and tends to decrease during electrodeposition indicating the formation of an insulating film.

Once the anionic electrodepositable coating composition is electrodeposited over the metal substrate, the coated substrate may be heated to a temperature and for a time sufficient to at least partially cure the electrodeposited coating on the substrate. As used herein, the term “at least partially cured” with respect to a coating refers to a coating formed by subjecting the coating composition to curing conditions such that a chemical reaction of at least a portion of the reactive groups of the components of the coating composition occurs to form a coating. The coated substrate may be heated to a temperature ranging from 200° F. to 450° F. (93° C. to 232.2° C.), such as 225° F. to 350° F. (107.2° C. to 176.7° C.). The curing time may be dependent upon the curing temperature as well as other variables, for example, film thickness of the electrodeposited coating, level and type of catalyst present in the composition and the like. For example, the curing time may range from 30 seconds to 90 minutes, such as 1 to 60 minutes, such as 2 to 30 minutes, such as 10 to 60 minutes, such as 20 to 40 minutes.

The coating composition may be applied directly to the metal substrate when there is no intermediate coating between the substrate and the coating composition. By this is meant that the substrate may be bare, as described below, or may be treated with one or more cleaning, deoxidizing, and/or pretreatment compositions as described below, or the substrate may be anodized.

As noted above, the substrates to be used may be bare metal substrates. By “bare” is meant a virgin metal substrate that has not been treated with any pretreatment compositions such as conventional phosphating baths, heavy metal rinses, etc. Additionally, bare metal substrates being used in the present disclosure may be a cut edge of a substrate that is otherwise treated and/or coated over the rest of its surface. Alternatively, the substrates may undergo one or more treatment steps known in the art prior to the application of the coating composition.

The metal substrate may optionally be cleaned using conventional cleaning procedures and materials. These would include mild or strong alkaline cleaners such as are commercially available and conventionally used in metal pretreatment processes. Examples of alkaline cleaners include Chemkleen 163 and Chemkleen 177, both of which are available from PPG Industries, Pretreatment and Specialty Products, and any of the DFM Series, RECC 1001, and 88X1002 cleaners commercially available from PRC-DeSoto International, Sylmar, CA), and Turco 4215-NCLT and Ridolene (commercially available from Henkel Technologies, Madison Heights, Mi). Such cleaners are often preceded or followed by a water rinse, such as with tap water, distilled water, or combinations thereof. The metal surface may also be rinsed with an aqueous acidic solution after or in place of cleaning with the alkaline cleaner. Examples of rinse solutions include mild or strong acidic cleaners such as the dilute nitric acid solutions commercially available and conventionally used in metal pretreatment processes.

At least a portion of a cleaned substrate surface may be deoxidized, mechanically or chemically. As used herein, the term “deoxidize” means removal of the oxide layer found on the surface of the substrate in order to promote uniform deposition of the pretreatment composition (described below), as well as to promote the adhesion of the pretreatment composition coating and/or curable film-forming composition of the present disclosure to the substrate surface. Suitable deoxidizers will be familiar to those skilled in the art. A typical mechanical deoxidizer may be uniform roughening of the substrate surface, such as by using a scouring or cleaning pad. Typical chemical deoxidizers include, for example, acid-based deoxidizers such as phosphoric acid, nitric acid, fluoroboric acid, sulfuric acid, chromic acid, hydrofluoric acid, and ammonium bifluoride, or Amchem 7/17 deoxidizers (available from Henkel Technologies, Madison Heights, MI), OAKITE DEOXIDIZER LNC (commercially available from Chemetall), TURCO DEOXIDIZER 6 (commercially available from Henkel), or combinations thereof. Often, the chemical deoxidizer comprises a carrier, often an aqueous medium, so that the deoxidizer may be in the form of a solution or dispersion in the carrier, in which case the solution or dispersion may be brought into contact with the substrate by any of a variety of known techniques, such as dipping or immersion, spraying, intermittent spraying, dipping followed by spraying, spraying followed by dipping, brushing, or roll-coating.

The metal substrate may optionally be pickled by treatment with solutions comprising nitric acid and/or sulfuric acid.

The metal substrate may optionally be pretreated with any suitable solution known in the art, such as a metal phosphate solution, an aqueous solution containing at least one Group IIIB or IVB metal, an organophosphate solution, an organophosphonate solution, and combinations thereof. The pretreatment solutions may be essentially free of environmentally detrimental heavy metals such as chromium and nickel. Suitable phosphate conversion coating compositions may be any of those known in the art that are free of heavy metals. Examples include zinc phosphate, which is used most often, iron phosphate, manganese phosphate, calcium phosphate, magnesium phosphate, cobalt phosphate, zinc-iron phosphate, zinc-manganese phosphate, zinc-calcium phosphate, and layers of other types, which may contain one or more multivalent cations. Phosphating compositions are known to those skilled in the art and are described in U.S. Pat. Nos. 4,941,930, 5,238,506, and 5,653,790.

The IIIB or IVB transition metals and rare earth metals referred to herein are those elements included in such groups in the CAS Periodic Table of the Elements as is shown, for example, in the Handbook of Chemistry and Physics, 63rd Edition (1983).

Typical group IIIB and IVB transition metal compounds and rare earth metal compounds are compounds of zirconium, titanium, hafnium, yttrium and cerium and mixtures thereof. Typical zirconium compounds may be selected from hexafluorozirconic acid, alkali metal and ammonium salts thereof, ammonium zirconium carbonate, zirconyl nitrate, zirconium carboxylates and zirconium hydroxy carboxylates such as hydrofluorozirconic acid, zirconium acetate, zirconium oxalate, ammonium zirconium glycolate, ammonium zirconium lactate, ammonium zirconium citrate, and mixtures thereof. Hexafluorozirconic acid is used most often. An example of a titanium compound is fluorotitanic acid and its salts. An example of a hafnium compound is hafnium nitrate. An example of a yttrium compound is yttrium nitrate. An example of a cerium compound is cerous nitrate.

Typical compositions to be used in the pretreatment step include non-conductive organophosphate and organophosphonate pretreatment compositions such as those disclosed in U.S. Pat. Nos. 5,294,265 and 5,306,526. Such organophosphate or organophosphonate pretreatments are available commercially from PPG Industries, Inc. under the name NUPAL.

In the aerospace industry, anodized surface treatments as well as chromium based conversion coatings/pretreatments are often used on aluminum alloy substrates. Examples of anodized surface treatments would be chromic acid anodizing, phosphoric acid anodizing, boric acid-sulfuric acid anodizing, tartaric acid anodizing, sulfuric acid anodizing. Chromium based conversion coatings would include hexavalent chromium types, such as BONDERITE M-CR1200 from Henkel, and trivalent chromium types, such as BONDERITE M-CR T5900 from Henkel.

After application of the spray-applied coating composition to the metal substrate, a film is formed on the surface of the substrate by driving solvent, i.e., organic solvent and/or water, out of the film by heating or by an air-drying period. Suitable drying conditions will depend on the particular composition and/or application, but in some instances a drying time of from about 1 to 5 minutes at a temperature of about 70 to 250° F. (27 to 121° C.) will be sufficient. More than one coating layer may be applied if desired. Usually between coats, the previously applied coat is flashed; that is, exposed to ambient conditions for the desired amount of time. The coating composition may then be heated. In the curing operation, solvents are driven off and crosslinkable components of the composition are crosslinked. The heating and curing operation is sometimes carried out at a temperature in the range of from 70 to 250° F. (27 to 121° C.) but, if needed, lower or higher temperatures may be used. As noted previously, the coatings of the present disclosure may also cure without the addition of heat or a drying step. Additionally, the first coating composition may be applied and then a second applied thereto “wet-on-wet”. Alternatively, the first coating composition can be cured before application of one or more additional coating layers.

Following coating of the metal substrate with a conformal coating composition, the metal substrate may be joined and/or adhered to the reinforced polymer layer. The metal substrate having the conformal coating composition may be joined or adhered to the reinforced polymer layer by any suitable method. For example, the layer comprising the metal substrate may further comprise a polymer matrix, and the metal substrate is embedded in the polymer matrix to be joined to the reinforced polymer layer. The polymer matrix may comprise the same or a different polymer than the reinforced polymer layer. The polymer matrix may also comprise the same or a different polymer than the coating composition. For example, the polymer matrix may comprise an epoxy resin. Regardless of the method of adhering or joining the metal substrate to the reinforced polymer layer, the composite structure does not include any intervening layer between the reinforced polymer layer and the layer comprising the aluminum substrate. For example, the composite structure does not include an isolation layer between the reinforced polymer layer and the layer comprising the aluminum substrate.

The metal substrate may also be sandwiched between reinforced polymer layers in the composite structure.

The composite structure may be produced by a layup process wherein a resin, such as an epoxy resin, is used to bond layers of the composite structure together, including the layer that comprises the metal substrate. Non-limiting examples of layup processes include wet layup and prepeg layup, and the processes may be manual or automated. The resin layers may be in the form of thermoplastic or thermosetting tapes that can be layered with the reinforcing material and the metal substrate. Additional processes include, for example, automated fiber placement (AFP), automated tape laying (ATL), resin transfer moulding (RTM), vacuum assisted resin transfer molding (VARTM), among others.

It has been surprisingly discovered that the use of the conformal coating on the metal substrate allows for the preparation of a composite structure that can avoid galvanic corrosion of the metal substrate without the use of an isolation layer. Without intending to be bound by theory, it is believed that the conformal organic coating provides improved barrier properties to the metal substrate that reduces or prevents the occurrence of galvanic corrosion of the metal substrate. For example, as described in the examples below, the metal substrate having the conformal organic coating may have a galvanic corrosion weight loss of less than 20% by weight, as measured according to GALVANIC CORROSION TEST METHOD described in the examples, such as less than 15% by weight, such as less than 10% by weight, such as less than 5% by weight, such as less than 3% by weight, such as less than 2% by weight, such as less than 1% by weight, such as less than 0.7% by weight. In addition, the conformal organic coating has a pore resistance of at least 10⁴ ohms as measured by the BARRIER PROPERTY TEST METHOD described herein, such as at least 105 ohms, such as at least 106 ohms, such as at least 107 ohms. The improved barrier properties and resistance to galvanic corrosion allows for a composite structure having a longer functional life by reducing the deterioration of the metal substrate and the properties and functions that it provides to the composite structure (e.g., lightning strike protection, electro-magnetic interference protection, etc.).

The composite structure may optionally further comprise a surfacing film. As used herein, the term “surfacing film” refers to a resinous film that may be applied to the outermost surface of a material in order to improve the surface quality of the material. For example, the surfacing film may be applied to a composite structure such that the surfacing layer is in contact with the mold used to form the composite part. The surfacing film may improve the quality of the surface of the formed composite structure to result in a more smooth surface of a molded composite part that requires minimal surface finishing before the application of the decorative coating(s). The surfacing film may be either fully or partially impregnated with thermoplastic or uncured thermosetting resin.

The surfacing film may comprise any suitable surfacing film. For example, the surfacing film may comprise a resin comprising a curable resin or a thermoplastic resin. For example, the surfacing film may comprise a curable epoxy resin; curable chain-extended epoxy resin; a urethane modified epoxy resin; a CTBN modified epoxy resin; a phenoxy resin; a micronized phenoxy resin; a phenolic hardener; a polyester resin, a vinyl ester; nylon; a polyetherketoneketone (PEKK); a polyetheretherketone (PEEK); a polyaryletherketone (PAEK); any other suitable polymer; or any combination thereof.

The surfacing film may optionally further comprise a core-shell rubber toughening agent.

The resin of the surfacing film may be the same or different than the polymer of the reinforced polymer layer.

The surfacing film may optionally comprise an electrically conductive layer, such as a metal layer, which may optionally be a foil, a sheet, a mesh, an expanded metal, a perforated metal, a woven metal, a grid, cloth, wires, or a combination thereof. The metal layer may be the same or different than the metal substrate described above, and may optionally comprise the conformal organic coating. The optional conformal organic coating may comprise a resin that is the same or different than the resin of the surfacing film.

The curable surfacing film may have any suitable thickness, such as, for example, between 0.025 and 1.0 mm.

The layered construction of the composite structure that includes the surfacing film may be made by any suitable method. For example, a curable surfacing film and a curable polymeric composite may be laid up, in that order, in a tool having a shape which is the inverse of the desired shape of the composite structure, and the curable surfacing film and reinforced polymer layer may be cured. Curing may be accomplished by, for example, application of heat, and optionally may be carried out under sub-atmospheric pressure, such as less than 90% of one atmosphere, such as less than 50% of one atmosphere, such as less than 10% of one atmosphere. Optionally, the composite structure may be further subjected to other optional processes such as pressure treatment using an autoclave (with vacuum bag) or a debulking process.

The present disclosure is also directed to a surfacing film comprising the porous metal substrate comprising a surface having a plurality of apertures and a conformal organic coating present on at least a portion of the surface of the porous metal substrate, described above. The conformal organic coating may comprise a resin that is the same or different than the resin of the surfacing film.

The present disclosure is also directed to a surfacing film comprising a metal layer comprising a conformal organic coating present on at least a portion of the surface of the porous metal substrate. The conformal organic coating may be any of those described above. The conformal organic coating may comprise a resin that is the same or different than the resin of the surfacing film.

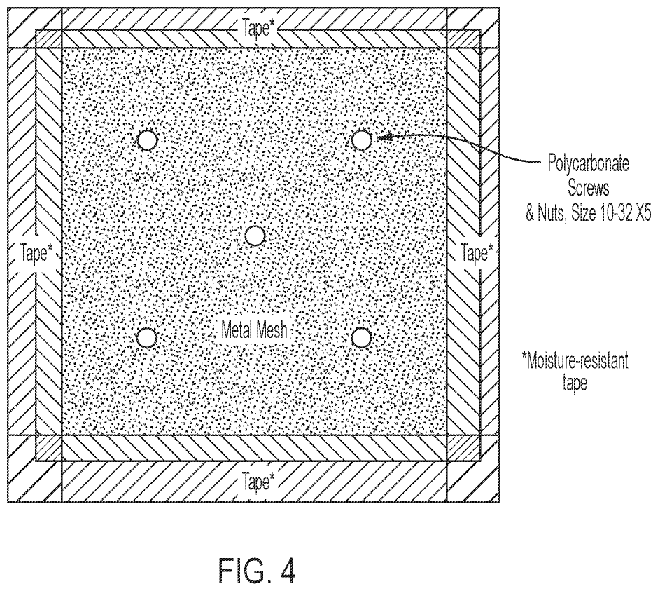

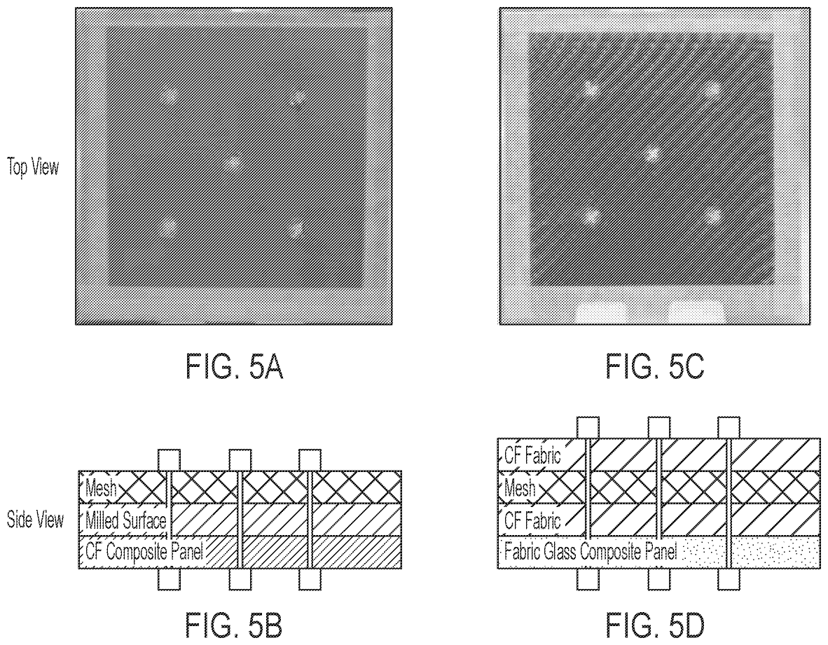

The present disclosure is also directed to a test method for evaluating the galvanic corrosion resistance of a metal substrate. The method comprises the steps of measuring the weight of a metal substrate test piece; forming a stack comprising the metal substrate test piece and a sheet or fabric comprising a material that is more noble than the metal substrate test piece such that the metal substrate test piece and sheet or fabric are in direct contact; fixedly adhering the stack using at least one non-conductive fastener (e.g., polycarbonate screws and nuts) to maintain contact between the metal substrate test piece and the sheet or fabric; subjecting the stack to a corrosion stimulus for a period of time (e.g., a salt fog chamber according to ASTM B117); rinsing to remove residual corrosion stimulus (e.g., by spraying) and separating the stack; reweighing the metal substrate test piece after it has dried; and comparing the reweighed weight to the original weight of the metal substrate test piece to determine weight loss. The weight loss will depend upon the metal substate test piece's susceptibility to galvanic corrosion relative to the sheet or fabric with more susceptible substrates having a higher weight loss. The stack may optionally further comprise a second sheet or fabric wherein each sheet and/or fabric are present on either face of the metal substrate test piece. The stack may optionally further comprise a non-conductive base (e.g., a fiberglass composite sheet) and moisture resistant tape may be used to secure the metal substrate test piece to the sheet or fabric. Non-limiting examples of this test method are presented in the Examples section below, and non-limiting examples of the configuration of the stack are presented in FIG. 4 and FIG. 5.

The composite structure may comprise any suitable structure. For example, the composite structure may comprise an aircraft airframe; an external structure mounted to an aircraft; an aircraft propeller; an aircraft rotor; a helicopter or helicopter component; a rocket fuel tank; a land motor vehicle body; a marine structure; a land structure; or a windmill or windmill components, among other structures.

Candidate locations and structures for use of the composite structure as a lightning strike protection material include: airframe (particularly skin portions thereof) including fuselage, wings, stabilizers and their subcomponents; external structures (e.g., engine nacelles, external fuel tanks, external weapon pods, electronic pods or other pods); internal structures (e.g., fuel tanks, equipment housings); propellers; and rotors. Similar uses may attend composite land vehicles or water vessels or windmill components (e.g., blades). Non-lightning applications may include radiofrequency isolation/containment (e.g., Faraday cages). When used to make any such otherwise conventional product, existing or yet-developed manufacturing techniques and basic materials may be used to which the exemplary composite structure is added.

The metal substrate of the composite structure may also be used as a resistive heating layer. The term “resistive-heating” is used herein to indicate heat is generated via a Joule heating in which the passage of an electric current through the metal substrate produces heat. The power of heating generated by resistive-heating of the metal substrate is proportional to the product of its electrical resistance and the square of the electric current. The resistive heating layer may be used as, for example, part of a de-icing system for a aircraft, helicopter, or windmill, among other uses.

The present disclosure is also directed to a method of making a composite structure, the method comprising fixedly adhering the coated metal substrate to at least one reinforced polymer layer comprising a reinforcing material, wherein the coated metal substrate is in direct contact with the reinforced layer, and the reinforcing material is more noble than the metal substrate. The method may further comprise applying the conformal metal coating to the metal substrate.

For purposes of the detailed description, it is to be understood that the disclosure may assume various alternative variations and step sequences, except where expressly specified to the contrary. Moreover, other than in any operating examples, or where otherwise indicated, all numbers such as those expressing values, amounts, percentages, ranges, subranges and fractions may be read as if prefaced by the word “about.” even if the term does not expressly appear. Accordingly, unless indicated to the contrary, the numerical parameters set forth in the following specification and attached claims are approximations that may vary depending upon the desired properties to be obtained by the present disclosure. At the very least, and not as an attempt to limit the application of the doctrine of equivalents to the scope of the claims, each numerical parameter should at least be construed in light of the number of reported significant digits and by applying ordinary rounding techniques. Where a closed or open-ended numerical range is described herein, all numbers, values, amounts, percentages, subranges and fractions within or encompassed by the numerical range are to be considered as being specifically included in and belonging to the original disclosure of this application as if these numbers, values, amounts, percentages, subranges and fractions had been explicitly written out in their entirety.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

As used herein, “including.” “containing” and like terms are understood in the context of this application to be synonymous with “comprising” and are therefore open-ended and do not exclude the presence of additional undescribed or unrecited elements, materials, ingredients or method steps. As used herein, “consisting of” is understood in the context of this application to exclude the presence of any unspecified element, ingredient or method step. As used herein, “consisting essentially of” is understood in the context of this application to include the specified elements, materials, ingredients or method steps “and those that do not materially affect the basic and novel characteristic(s)” of what is being described.

In this application, the use of the singular includes the plural and plural encompasses singular, unless specifically stated otherwise. For example, although reference is made herein to “a” reinforcing material, “a” film-forming resin, “an” ionic film-forming resin, “a” curing agent, a combination (i.e., a plurality) of these components may be used. In addition, in this application, the use of “or” means “and/or” unless specifically stated otherwise, even though “and/or” may be explicitly used in certain instances.

As used herein, the terms “on,” “onto,” “applied on,” “applied onto,” “formed on,” “deposited on.” “deposited onto,” mean formed, overlaid, deposited, or provided on but not necessarily in contact with the surface. For example, a coating composition “deposited onto” a substrate does not preclude the presence of one or more other intervening coating layers of the same or different composition located between the coating composition and the substrate.

Whereas specific aspects of the disclosure have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the disclosure which is to be given the full breadth of the claims appended and any and all equivalents thereof.

Illustrating the disclosure are the following examples, which, however, are not to be considered as limiting the disclosure to their details. Unless otherwise indicated, all parts and percentages in the following examples, as well as throughout the specification, are by weight.

### EXAMPLES

TABLE 1
A description of materials used in preparation of the examples.

| Component | Description | Supplier |
|---|---|---|
| ACRS2200 | AEROCRON ™ Resin Feed | PPG Industries |
| ACPP2220 | AEROCRON ™ Pigment Paste | PPG Industries |
| ACCP2240 | AEROCRON ™ Inhibitor Paste | PPG Industries |
| CA 7502 | Chrome-Free Exterior Epoxy Primer | PPG Industries |
| | (including base, activator, and thinner | |
| | components) | |
| 4AL8-080F | Aluminum Mesh Screen | PPG Dexmet |
| BONDERITE ® C-AK 298 | Alkaline Immersion Cleaner | Henkel |
| BONDERITE ® C-IC DEOXDZR | Deoxidizer | Henkel |
| 6MU AERO/BONDERITE ® C-IC | | |
| DEOXDZR 16R AERO | | |
| BONDERITE ® C-AK 6849 AERO | Alkaline Immersion Cleaner | Henkel |
| CLEANER | | |
| BONDERITE ® C-IC SMUTGO NC | Deoxidizer | Henkel |
| AERO | | |
| ACRS2100 | AEROCRON ™ Resin Feed | PPG Industries |
| ACPP2120 | AEROCRON ™ Pigment Paste | PPG Industries |
| ACCP2140 | AEROCRON ™ Initiator Paste | PPG Industries |
| Carbon Composite Sheets (8181K231) | Carbon Composite Sheet | McMaster |
| TORAYCA ® T300, 3K Tow, Twill | Standard Modulus Carbon Fiber Fabric | RockWest |
| Weave | | Composites |
| Garolite G-10/FR4 Sheets | Fiberglass Composite Sheet | McMaster |
| (85345K713) | | |
| Toray FM6673G-37K-965 | Carbon Fiber Prepreg | Toray |
| Toray FGF108-29M-990 | Fiberglass Prepreg | Toray |
| 09W015 | Chrome-Free Polyurethane High Build | PPG Industries |
| | Sanding Surfacer | |
| DESOTHANE ® HS CA8000/B70846 | Polyurethane Exterior Topcoat | PPG Industries |
| | (Including base, activator, and thinner | |
| | components) | |
| Multiprime 4160 | Alkyd Primer | PPG Industries |

### Example 1: Preparation of Porous Metal Substrate Having an Electrodeposited Coating

TABLE 2
Components of Electrodepositable Coating Composition

| Material | Weight (g) |
|---|---|
| Charge 1 | |
| ACRS2200 | 1067.82 |
| Charge 2 | |
| ACPP2220 | 150.25 |
| Charge 3 | |
| ACCP2240 | 172.37 |
| Charge 4 | |
| Distilled Water | 1409.56 |
| Total Blended Weight | 2800 |

The electrodepositable coating composition of Example 1 was prepared by the following procedure: Charge 1 was added to a 1 gallon plastic bucket and agitation was started and maintained during the addition of the remaining charges. Charge 2 was added slowly over 5 minutes. Then, Charge 3 was added over 5 minutes. Finally, Charge 4 was added over 5 minutes. The resulting mixture stirred for an additional 15 minutes. The electrodepositable coating composition was then ultrafiltered to remove 50% of the original mass of the bath which was replaced with additional deionized water to return it to the original starting weight.

The electrodepositable coating composition from Table 2 was electrodeposited onto aluminum mesh substrates (product code 4AL8-080F commercially available from PPG Dexmet).

Prior to electrodeposition coating application, the aluminum mesh substrates were immersed in BONDERITE® C-AK 298 ALKALINE CLEANER (previously known as Ridoline® 298 and commercially available from Henkel) for 2 minutes at 130° F. followed by a 1-minute immersion in tap water and a spray rinse of tap water. The mesh was then immersed in a deoxidizing bath consisting of BONDERITE® C-IC DEOXDZR 6MU AERO/BONDERITE® C-IC DEOXDZR 16R AERO (previously known as Turco® Deoxidizer 6 Makeup and Turco® Deoxidizer 16 Replenisher, both commercially available from Henkel) for 2.5 minutes at ambient conditions; followed by a 1-minute immersion in tap water and finally a spray rinse of deionized water. The mesh was allowed to dry under ambient conditions for at least 2 hours prior to coating electrodeposition.

The electrodepositable coating composition was electrodeposited onto the aluminum mesh substrates using a current of between 0.3 and 1.5 amps for 140 seconds at a bath temperature of 80° F. using voltages between 100 and 250 volts. The electrodeposited coating was applied onto the aluminum mesh substrates to a coating thickness ranging from 0.5 mils to 5 mils (12.7-127 microns). The electrodeposited coating was cured at 250° F. for 60 minutes.

### Example 2: Preparation of Porous Metal Substrate Having a Spray-Applied Coating

TABLE 3
Components of Liquid, Chrome-Free Spray Primer

| Material | Weight (g) |
|---|---|
| Charge 1 | |
| CA 7502 Base | 58.07 |
| Charge 2 | |
| CA 7502 Activator | 47.23 |
| Charge 3 | |
| CA 7502 Thinner | 10.51 |
| Total Blended Weight | 115.81 |

The liquid, spray-applied primer coating composition was prepared by the following procedure: Charge 1 was agitated separately for 10 minutes and added to Charge 2 with hand stirring. Charge 3 was then added to the blend and stirred for another 10 minutes. The blend was subjected to an induction time of 1 hour at room temperature. The blend was then sprayed on aluminum mesh substrates (produce code 4AL8-080F available from PPG Dexmet) using a High Volume Low Pressure (HVLP) spray gun (Anest Iwata LPH-300) at 30 psi air pressure setting. The spray distance was 6-12 inches with 2-4 spray passes at the front and at the back of the aluminum mesh substrate, respectively. The applied coating was allowed to cure at ambient temperature for 24 hours. The resulting thickness of the coating on the mesh screen was 0.4-1.2 mils (10-30 microns).

### Preparation of Composite Structures and Galvanic Corrosion Testing

The electrocoated and spray-coated aluminum mesh substrates were included in composite structures and tested for galvanic corrosion by placing the aluminum mesh substrates in contact with carbon composite components/sheets in 2 stack-up configurations: i) on a carbon composite sheet surface milled to a depth of 0.008″ (200 microns) (product code 8181K231 commercially available from McMaster-Carr) and ii) embedded between two pieces of standard modulus carbon fiber fabrics (TORAYCA® T300, 3K Tow Size, Twill Weave). These configurations were based on a set-up as shown in FIG. 4 and FIG. 5. A piece of the coated aluminum mesh substrate was cut to a dimension of 5.5″×5.5″ with five holes (0.19″ diameter) at the center and in a pattern according to FIG. 4. The coated aluminum mesh substrate was weighed and placed on a 6″×6″ base panel. For the first configuration, the base panel was the surface-milled carbon composite sheet, while for the second configuration, it was a Garolite G-10/FR4 fiberglass composite sheet. The coated aluminum mesh substrate was adhered to the base panel by moisture-resistant tape on the edges according to the dimensions in FIG. 4 and further secured by five polycarbonate screws and nuts. Schematics of the two stack-up configurations is shown in FIG. 5. This procedure was also conducted with an uncoated aluminum mesh substrate (produce code 4AL8-080F available from PPG Dexmet) as a comparative example.

The stacked-up composite structures were placed in a salt fog chamber for exposure to a corrosive environment according to the test standard ASTM B117. The test was conducted for 28 days with visual inspection on the samples occurring at every 3-4 days. After 28 days of testing, the samples were deionized-water-rinsed, air-dried, and separated from the stack-up. The resulting weight of the sample meshes were then measured.

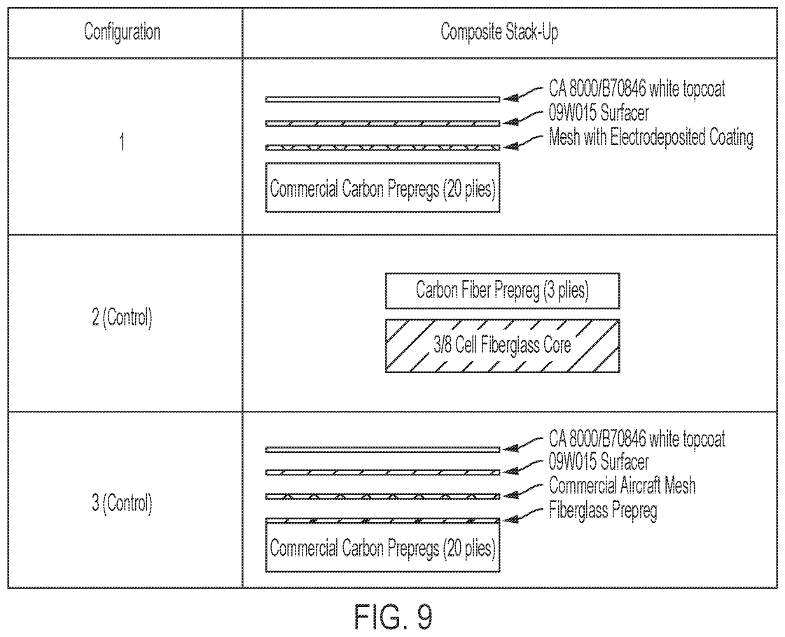

Tables 4A and 4B show the weight change for an uncoated aluminum mesh substrate, an electrocoated aluminum mesh substrate, and a spray-applied primer mesh after immersion in a salt fog environment in the two different stack-up configurations. It should be noted that the uncoated aluminum mesh substrate-containing comparative example was only subjected to the salt fog environment for 4 days due to severe sample disintegration from galvanic corrosion. Weight loss for these comparative examples was 23.77% for the carbon composite sheet configuration (FIG. 5A and FIG. 5B) and 69.63% for the carbon fiber fabric configuration (FIG. 5C and FIG. 5D). In comparison, the weight change for the electrocoated aluminum mesh substrate after 28 days salt fog exposure in both stack-up configurations was less than 1%. The weight change for the spray-applied primer coated aluminum mesh substrate after 28 days salt fog exposure was 0.55% for the carbon composite sheet configuration (FIG. 5A and FIG. 5B) and 9.81% for the carbon fiber fabric configuration (FIG. 5C and FIG. 5D).

TABLE 4A
Weight loss of uncoated, electrocoated, and spray-applied
primer aluminum mesh substrates for sample stack-up of the
carbon composite sheet configuration (FIG. 5A and 5B).

| | Pre-Test | Post-Test | Weight |
|---|---|---|---|
| | Weight (g) | Weight (g) | Loss (%) |
| Uncoated Aluminum Mesh | 1.4920 | 1.1373 | 23.77 |
| Substrate (4 day test) | | | |
| Electrocoated Aluminum Mesh | 2.9286 | 2.9206 | 0.27 |
| Substrate (28 day test) | | | |
| Spray-Applied Primer Coated | 2.1129 | 2.1013 | 0.55 |
| Aluminum Mesh Substrate | | | |
| (28 day test) | | | |

TABLE 4B
Weight loss of uncoated, electrocoated and spray primer meshes for
sample stack-up configuration 2: mesh embedded between two pieces
of standard modulus carbon fiber fabrics (FIG. 5C and 5D).

| | Pre-Test | Post-Test | Weight |
|---|---|---|---|
| | Weight (g) | Weight (g) | Loss (%) |
| Uncoated Aluminum Mesh | 1.4885 | 0.4520 | 69.63 |
| Substrate (4 day test) | | | |
| Electrocoated Aluminum Mesh | 3.0292 | 3.0110 | 0.60 |
| Substrate (28 day test) | | | |
| Spray-Applied Primer Coated | 2.1245 | 1.9161 | 9.81 |
| Aluminum Mesh Substrate | | | |
| (28 day test) | | | |

### Example 3: Preparation of Porous Metal Substrate Having an Electrodeposited Coating

TABLE 5
Components of Electrodepositable Coating Composition

| Material | Weight (g) |
|---|---|
| Charge 1 | |
| ACRS2100 | 1455.95 |
| Charge 2 | |
| ACPP2120 | 324.37 |
| Charge 3 | |
| ACCP2140 | 122.39 |
| Charge 4 | |
| Distilled Water | 1897.30 |
| Total Blended Weight | 3800 |

The electrodepositable coating composition of Example 3 was prepared by the following procedure: Charge 1 was added to a 1 gallon plastic bucket and agitation was started and maintained during the addition of the remaining charges. Charge 2 was added slowly over 5 minutes. Then, Charge 3 was added over 5 minutes. Finally, Charge 4 was added over 5 minutes. The resulting mixture stirred for an additional 15 minutes. The electrodepositable coating composition was then ultrafiltered to remove 50% of the original mass of the bath which was replaced with additional deionized water to return it to the original starting weight.

The electrodepositable coating composition from Table 5 was electrodeposited onto aluminum mesh substrates (product code 4AL8-080F commercially available from PPG Dexmet).

Prior to electrodeposition coating application, the aluminum mesh substrates were immersed in BONDERITE® C-AK 6849 AERO CLEANER for 5 minutes at 130° F. followed by a 2.5-minute immersion in distilled water and a spray rinse of distilled water. The mesh was then immersed in a deoxidizing bath consisting of BONDERITE® C-IC SMUTGO NC AERO for 3 minutes at ambient conditions; followed by a 2-minute immersion in distilled water and finally a spray rinse of deionized water. The mesh was allowed to dry under ambient conditions for at least 2 hours prior to coating electrodeposition.

The electrodepositable coating composition was electrodeposited onto the aluminum mesh substrates using a current of 0.5 amps for a time between 85 and 105 seconds at a bath temperature of 75° F. using a voltage of 150 volts. The electrodeposited coating was applied onto the aluminum mesh substrates to a coating thickness ranging from 0.5 mils to 1.5 mils (12.7-38.1 microns). The electrodeposited coating was cured at 250° F. for 60 minutes.

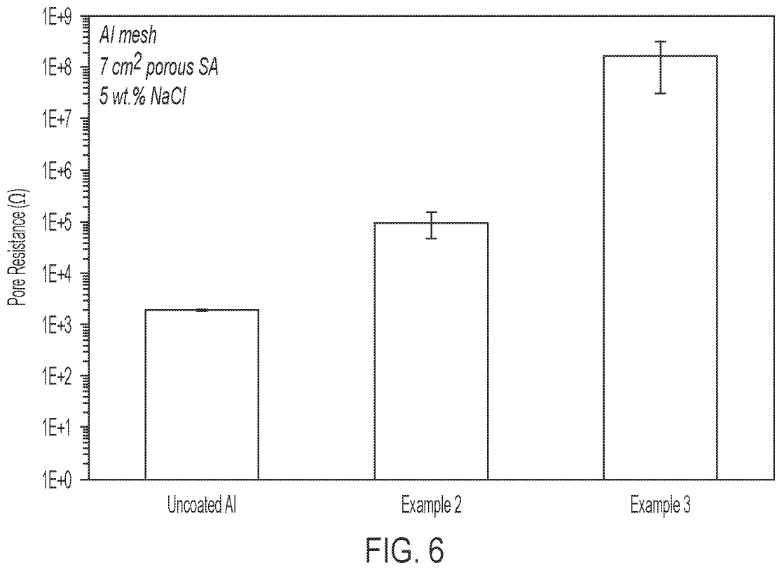

Electrochemical impedance spectroscopy (EIS) was conducted to assess barrier property using a Gamry Interface 1000 potentiostat. The porous metal substrates analyzed were the porous metal substrate having a spray-applied coating of Example 2, the porous metal substrate having an electrodeposited coating of Example 3, and a bare porous metal substrate (product code 4AL8-080F commercially available from PPG Dexmet) as a control. EIS measurements were performed using a three-electrode cell with the porous metal substrate sample as the working electrode, Ag/AgCl reference electrode, and Pt counter electrode in quiescent 5 wt. % NaCl electrolyte. After a 30 minute open circuit potential hold, an EIS scan was acquired in swept sine mode from 100 kHz to 0.01 Hz with six points per decade at an AC amplitude of 10 mV. At least duplicate scans were conducted per sample, each with a porous surface area of 7 cm². The impedance spectra were circuit fitted to estimate the pore resistances (in (Ω) of the coating of the coated porous metal substrate and the bare porous metal substrate (i.e., the oxides present on the substrate surface) samples. The results are presented in the graph of FIG. 6. This test is referred to herein as the BARRIER PROPERTY TEST METHOD.

As shown in FIG. 6, the porous metal substrate having a spray-applied coating of Example 2 and the porous metal substrate having an electrodeposited coating of Example 3 had significantly improved pore resistance compared to the bare porous metal substrate.

### Galvanic Current Measurement of Porous Metal Substrate Having an Electrodeposited Coating

Galvanic current measurement was conducted to assess the effectiveness of the electrodeposited coating used in making the porous metal substrate of Example 3 in protecting the aluminum mesh from galvanic corrosion when in contact with a carbon composite material. The electrocoat formula, film thickness and bake conditions are the same as Example 3. However, the bath size changed which required the voltage, amperage and time to vary. For these particular examples, the voltage was set at 270 V with a current of 15 amps max and the coating time was 360 seconds with a 60 second ramp. The current after the 60 second ramp was between 7.5 and 8 amps. A single ply of aircraft-grade carbon fiber prepreg (Toray FM6673G-37K-965) was autoclaved. The edges of a mesh with the electrodeposited coating, 3″×3″, was dip coated with a primer (Multiprime 4160) at a depth of approximately ⅙″ and cured for 7 days under ambient conditions. The mesh was then placed in direct contact with the autoclaved carbon fiber prepreg, and in a beaker containing quiescent 5 wt. % NaCl electrolyte. This assembly was connected to a Gamry Interface 1000 potentiostat for a 72-hour galvanic current measurement. The control sample was an assembly of uncoated aluminum mesh in direct contact with a single ply, autoclaved carbon fiber prepreg.

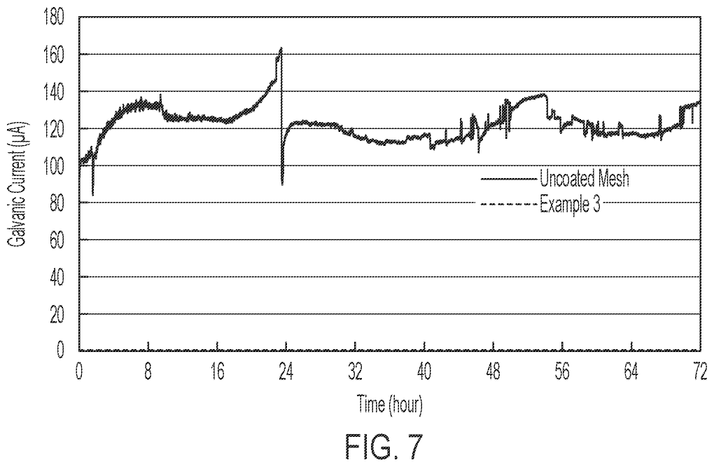

Galvanic currents of the mesh with electrodeposited coating and control mesh over a 72-hour period is shown in FIG. 7. Results showed minimal galvanic current on the mesh with electrodeposited coating. This indicated that the electrodeposited coating successfully provided a barrier between the underlying aluminum substrate and carbon fiber prepreg material. This is in comparison to the uncoated mesh control sample where the galvanic current was higher than the mesh with electrodeposited coating by two orders of magnitude.

Galvanic Corrosion Test of Aircraft-Grade Composite Structures Embedded with Porous Metal Substrate Having an Electrodeposited Coating

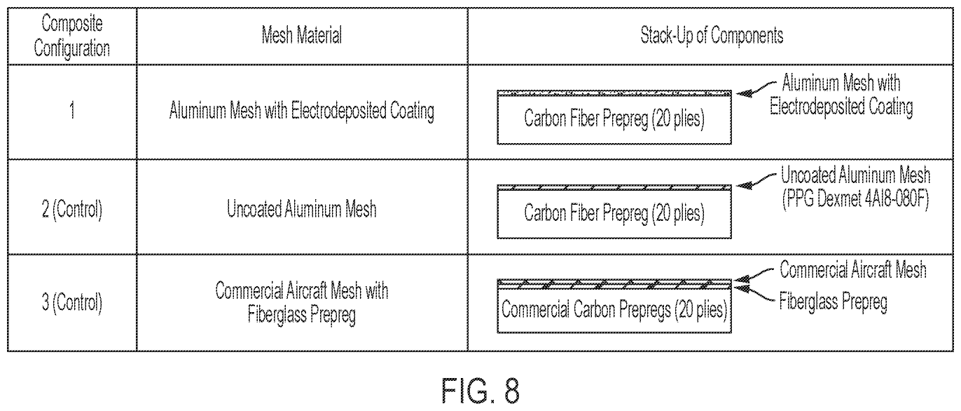

Galvanic corrosion test of aircraft-grade carbon composite structures embedded with mesh having an electrodeposited coating (as described in Example 3) and control meshes were conducted. The structures (3″×3″ size) were fabricated in configurations as shown in FIG. 8. Each of these configurations contained 20 plies of carbon fiber prepreg (Toray FM6673G-37K-965) and were manually laid up with three different mesh material, i.e., aluminum mesh with electrodeposited coating, uncoated aluminum mesh, and current commercial aircraft mesh (anodized and conversion coated aluminum mesh) with a fiberglass prepreg (Toray FGF108-29M-990). These configurations were autoclaved to form cohesive composite structures. Three samples were fabricated for each configuration.

The composite structures were placed in a salt spray chamber for 30 days to test for effectiveness in galvanic corrosion protection, according to test standard ASTM B-117. After the test, the samples were deionized-water-rinsed, air-dried and rated according to corrosion severity guidelines listed in Table 6. Three samples were prepared for each composite structure and the results were averaged. A higher rating indicated severe corrosion and a lower rating indicating less corrosion (or no corrosion).

TABLE 6
Corrosion Severity Rating Based on Percentage
Area of Visible Corrosion

| Rating | Percentage Area of Corrosion on Panel |
|---|---|
| 5 | ≥40% |
| 4 | 30.1%-40% |
| 3 | 20.1%-30% |
| 2 | 10.1%-20% |
| 1 | ≤10% |
| 0 | No Corrosion |

Table 7 shows the averaged rating for each panel configuration. Results showed that composite structures embedded with aluminum mesh with electrodeposited coating provided galvanic corrosion protection on par with the commercial aircraft mesh configuration having an isolation ply.

TABLE 7
Corrosion Severity Rating of Aircraft-Grade Composites
Structures After 30-day Salt Fog Exposure

| Sample | Averaged Rating |
|---|---|
| Uncoated Aluminum Mesh | 3 |
| Aluminum Mesh with Electrodeposited | 1 |
| Coating | |
| Current Commercial Aircraft Mesh with | 1 |
| Fiberglass Prepreg | |

Lightning Strike Test of Aircraft-Grade Composite Structures Embedded with Porous Metal Substrate Having an Electrodeposited Coating

A lightning strike test was conducted on 24″×24″ aircraft-grade composite structures embedded with aluminum mesh of electrodeposited coating (as described in Example 3) and control examples fabricated in configurations as shown in FIG. 9. The control samples were: a composite structure with no embedded mesh (3 plies of carbon fiber prepregs on ⅜ cell fiberglass core, Configuration 2 in FIG. 9), and a composite structure with current commercial aircraft mesh with fiberglass prepreg isolation ply (Toray FGF108-29M-990) (Configuration 3 in FIG. 9). These configurations are shown in FIG. 9. A high build sanding surfacer (PPG 09W015) and exterior topcoat (PPG DESOTHANE® HS CA8000/B70846) were applied on composite structures embedded with electrocoated (configuration 1) and commercial mesh (configuration 3), and at a combined coating thickness of approximately 200 μm. The lightning strike test was conducted in accordance with SAE ARP5412 Aircraft Lightning Environment and Related Test Waveforms, for Strike Zone 1A.

Lightning strike damage results showed that composite structures with electrocoated mesh (Configuration 1) and commercial mesh (Configuration 3) passed Strike Zone 1A test with no damage to the carbon composite structure. Comparatively, the composite structure without embedded mesh (Configuration 2) was punctured after being struck by the simulated lightning.

It will be appreciated by skilled artisans that numerous modifications and variations are possible in light of the above disclosure without departing from the broad inventive concepts described and exemplified herein. Accordingly, it is therefore to be understood that the foregoing disclosure is merely illustrative of various exemplary aspects of this application and that numerous modifications and variations can be readily made by skilled artisans which are within the spirit and scope of this application and the accompanying claims.

1. A composite structure comprising:
at least one reinforced polymer layer comprising a reinforcing material;
a layer comprising a metal substrate comprising a surface and a conformal organic coating present on at least a portion of the surface;
wherein the layer comprising the metal substrate is in direct contact with the reinforced polymer layer, and the reinforcing material is more noble than the metal substrate.

2. The composite structure of claim 1, wherein the reinforcing material comprises carbon fiber, chopped fiber, non-continuous fiber, metal flake, or any combination thereof.

3. The composite structure of claim 1, wherein the metal substrate comprises a porous metal substrate and the surface of the porous metal substrate comprises a plurality of apertures, wherein the porous metal substrate comprises a mesh, an expanded metal, a perforated metal, a woven metal, a grid, or a combination thereof.

4-5. (canceled)

6. The composite structure of claim 3, wherein the conformal organic coating is present as a film over the surface of the porous metal substrate.

7. The composite structure of claim 6, wherein the film extends into the aperture but does not seal the aperture.

8. The composite structure of claim 6, wherein the film conforms to the metal that defines the aperture and reduces the surface area of the aperture by less than 50% as compared to the surface area of the aperture before the metal substrate is coated.

9-15. (canceled)

16. The composite structure of claim 1, wherein the metal substrate has a thickness without the conformal coating of 0.015 to 1 mm, and the conformal organic coating has a thickness of 10 to 250 microns.

17-18. (canceled)

19. The composite structure of claim 1, wherein the metal substrate comprises aluminum or an aluminum alloy.

20. (canceled)

21. The composite structure of claim 1, wherein the conformal organic coating has a pore resistance of at least 10⁴ ohms as measured by the BARRIER PROPERTY TEST METHOD.

22. (canceled)

23. The composite structure of claim 1, wherein the conformal organic coating comprises an electrodepositable coating.

24-27. (canceled)

28. The composite structure of claim 1, wherein the conformal organic coating comprises a spray-applied coating.

29. The composite structure of claim 1, wherein the layer comprising the metal substrate further comprises a polymer matrix, and the metal substrate is embedded in the polymer matrix.

30-31. (canceled)

32. The composite structure of claim 1, wherein the composite structure does not include an isolation layer between the reinforced polymer layer and the layer comprising the metal substrate.

33. The composite structure of claim 1, wherein the composite structure does not include any intervening layer between the reinforced polymer layer and the layer comprising the metal substrate.

34. The composite structure of claim 1, wherein the metal substrate has a galvanic corrosion weight loss of less than 20% by weight, as measured according to GALVANIC CORROSION TEST METHOD.

35. The composite structure of claim 1, further comprising a surfacing film.

36-43. (canceled)

44. The composite structure of claim 1, wherein the composite structure comprises an aircraft surface component, an airframe structure, a helicopter fuselage, a helicopter rotor blade, a land-based motor vehicle, a marine vehicle, a marine structure, a windmill, a building, sporting goods, or a part thereof.

45-46. (canceled)

47. A vehicle or vehicle part comprising the composite structure of claim 1.

48-51. (canceled)

52. A surfacing film comprising a metal substrate comprising a surface and a conformal organic coating present on at least a portion of the surface of the metal substrate.

53-66. (canceled)

67. A method of making the composite structure of claim 1, the method comprising:
applying a conformal organic coating to a surface of a metal substrate to form a coated metal substrate; and
fixedly adhering the coated metal substrate to at least one reinforced polymer layer comprising a reinforcing material, wherein the coated metal substrate is in direct contact with the reinforced layer, and the reinforcing material is more noble than the metal substrate.

68-73. (canceled)
